(19) United States
(12) Patent Application Publication
(10) Pub. No.: US 2004/0225716 A1
(43) Pub. Date: Nov. 11, 2004

(54) Methods and systems for allowing a group of users to interactively tour a computer network

(76) Inventors: Ilan Shamir, Berkeley, CA (US); Miron Cuperman, San Francisco, CA (US)

Correspondence Address: DAVID S. KERVEN, JONES DAY, 1420 PEACHTREE ST, NE, SUITE 800, ATLANTA, GA, 30309-3053, US

(21) Appl. No.: 10/818,787

(22) Filed: Apr. 6, 2004

Related U.S. Application Data
(62) Division of application No. 09/583,337, filed on May 31, 2000.

(51) Int. Cl. G06F 15/16

(52) U.S. Cl. 709/204

(57) ABSTRACT

An invention is disclosed that uses methods and systems for enhancing users' Web surfing experiences by providing various functions including: delivery of content that is related to the user's present location or actions; providing collaborative browsing tools that manage the participants' rights interactively to control a particular collaborative browsing session; aggregating and then sharing with users information related to a particular Web site, action or object on the Internet; and offering various types of predefined collaborative browsing sessions in order to enhance the users' online experiences. These and other functions are accomplished via a browser companion that is downloaded or incorporated into the users' Web browsers. The browser companion communicates with a back-end server architecture that couples to various databases. The browser companion provides the appropriate server(s) with information about each user's present location or action within the network, e.g., Internet. The servers provide the browser companion with the information related to the user's present location or action, such as links, other ongoing collaborative browsing or chat sessions, community groups, or bulletin boards. Likewise, a session server manages the users collaborative browsing session and tracks the various administrative privileges that are dynamically assigned to each session participant based on the status of the session, the status of the user and the user's requests for particular rights.

### FIELD OF THE INVENTION

This invention relates to systems and methods for improving user's experiences in browsing or surfing a computer network such as the Internet, and particularly to methods and systems for making the experience of surfing the World Wide Web (“Web”) more collaborative, context-sensitive, interactive and productive.

### BACKGROUND OF THE INVENTION

Many of us are familiar with browser programs, such as Microsoft Internet Explorer or Netscape Navigator. These programs allow users to interface and use one of the most popular aspects of the Internet, the World Wide Web. Web surfing has traditionally been an individualized rather than collaborative experience. Various providers have offered users ways to personalize their Web experience by providing the user with a site on the Web that provides personalization features such as stock portfolio information, sports, weather or news. Some of the most popular Internet applications have created individualized sessions, e-mail, chat or instant messaging. These features allow users of the Internet to communicate to one another during their Web surfing experiences.

There are several advanced chat programs available via the Web. A company called Hypernix offers a “Gooey” program through its Web site. When you launch your browser and visit a site, the Gooey program lists other Gooey users currently browsing that site. This program allows users the opportunity to chat, add other users to their buddy list, or run video conference sessions, attaching those functions to particular and individual Web pages. Another company offers chat program called myESP. This program is not site based; that is, users do not have to be on the same Web site in order to locate each other and chat. The myESP service links people based on the similarity of their Web search terminology. As long as their interests are similar, myESP identifies and alerts “Topic Buddies” to each other's presence and allows them to link up anonymously. The myESP services allow users to post questions, check e-mail, or engage in any online or offline activity. MyESP will alert users when someone is ready to join them or respond to the question. ICQ offers a similar Internet tool that informs the users when their Internet friends are on-line so they can chat.

Several companies have also offered a collaborative browsing service. These programs allow several users to share one user's browsing experience. For instance, a company called Webex allows multiple “conference” participants to view each others data over the Web. They are also able to send control over the conference to another user. Likewise, U.S. Pat. No. 5,944,791 to Scherpbier describes a collaborative Web browser that resends to “follower” users the Web pages viewed by the session leader, with the hyperlinks disabled. There are “Web collaboration” or “shared browsing” services available that use “URL Pushing,” by which one person sends a Web page to another person's browser. The main problem with this technology is that users are generally not on the same Web page at the same time—yet this is the fundamental function and benefit of collaborative browsing and navigation.

A company called Hipbone offers an Internet collaborative navigator that allows sales and customer service agents to “connect browsers” and navigate a site with their customers. However, the service is site-specific and limited to agents and customers. U.S. Pat. No. 5,809,247 to Richardson, et al. similarly provides a method and apparatus for guided touring of a Web site. Yet the methods of that patent rely on a tour guide predefining the tour, thus greatly limiting the flexibility of the guided touring sessions. Moreover, none of these services offer truly collaborative experiences because the agent maintains control over the pace and travel of the browsing experience throughout the entire session.

Another problem with the Internet is simply the vast amount of information clamoring for the user's attention. Search engines have proliferated to make sense of the cacophony of attractions. But search engines are time consuming because, unless the search is susceptible to a precision request, multiple relevant sites are usually discovered. Thus, users spend substantial time investigating all the sites presented. Third parties like Alexa have provided information related to a particular link, but not in any useful fashion.

Search engines also do not allow users to store their results for future use. Even though present Internet browsers allow users to store as a “bookmark” or favorite” particular universal resource locator (“URL”) addresses, users are not otherwise able to annotate or attach materials to particular Web sites they visited. However, when visiting the site at a later time, the user may not recall the key portions or most useful features of a particular site. Third Voice has sought to remedy this specific problem via a service by which users can post notes onto a Web site and designate the notes as private, to be shared with a specific group, or to be shared with any Third Voice subscriber.

Each of these various services may improve a particular aspect of users' Internet surfing experiences but no service aggregates multiple tools and communication features into one easily accessible service. For instance, users cannot take their personalized data with them as they surf the Internet. Or, when users are co-navigating the Internet, the services they use lack the ability to share leadership among participants in order to form a true collaborative browsing environment. In short, to date, people have had to use too many separate, inefficient and poorly integrated tools to navigate and interact on the Web—including, among others, search engines, chat rooms, or segmented communities.

### SUMMARY OF THE INVENTION

Certain terms that are used in this summary are explained in more detail below, such as in the “terminology” section.

This invention aims to improve the Internet surfing experience to make it collaborative, interactive, context-sensitive and community-based for a single user or groups of users, whether the groups are public or private. In one aspect, the invention comprises a browser companion that provides the user with a broader context while the user tours or surfs the Web. The browser companion automatically displays information and people relevant to a particular user's present activity—e.g., links relevant to the sites visited by the user or contact information concerning other users' knowledgeable of or interested in the site visited or action undertaken by a first user. The browser companion aggregates information, communities and ideas seamlessly into the surfing activity. A back-end server architecture supports the browser companion, providing the necessary information. The browser companion offers an intelligent, online navigation application, bringing together content, community, customization and commerce organized around the very sites users are browsing. This invention adds these multiple elements to Web surfing in each location the users visit; information provided during any particular visit includes information on related sites, access to people viewing these sites, and products that are relevant to the site that the user is visiting. These and various other aspects of the invention and its implementation are described below:

Personalized User Browser Experience: While a user surfs the Web, the browser companion communicates with various back-end servers in order to provide information and services related to the user's location. The related information may be presented as a sidebar, e.g., a separate split-screen browser window. Via this sidebar, users can access a range of functional features that enhances their Web experience. The browser companion of this invention accompanies users wherever they go on the Web, providing the user with content, community, customization and commerce. Those features are described below:

Content: This includes information sources on or associated with the Internet that are related to a user's location. The back-end architecture that supports the browser companion (1) determines the users present location based on updates from the browser companion, (2) aggregates sources of related information into one or more databases, and (3) draws from the database(s) to suggest to the user information related to the user's present location.

Community: Users can read what other visitors to a particular site, or group of sites, have to say and add comments. Users can also chat with others who are browsing in the same neighborhood of sites, or share ideas and information with other users or groups via a bulletin board, notes feature, groups notes features, or real-time chat services by which users discuss the subject of a Web page being viewed with others interested in that subject. These features let users surf the Web together.

Customization: Users can post passwords, personal notes, etc. to the sites they visit and add relevant links and commentary. Users can also highlight sentences on the page for future use. These materials and actions may be highly secure so that the user can be confident of privacy.

Commerce: Users can view products and services on the Web that are related to their Web location, e.g., the Web site they are visiting.

Interactive and Collaborative Browsing Sessions: Another aspect of the invention provides a service to users whereby collaborative browsing sessions are established. During those sessions, the participants' browsers receive information about the location (e.g., site) of a leader's browser as the leader tours or surfs the Web or a particular Web site. Thus, the participants' browsers are able to display to the participants exactly what the leader is viewing. The invention manages any changes in the leadership and participant status of a particular collaborative-browsing session. In other words, collaborative browsing session participants are assigned different rights during the session that enables for participants various functions that enhance the interactive and collaborative nature of the session. For instance, if multiple users are surfing the Internet together in a collaborative-browsing session, the invention allows the lead user to hand-off leadership to another user participating in the multi-user co-browsing session. Alternatively, a host of other administrative user rights may be provisioned and managed. By way of example, leaders or others can ban disruptive users from the session, or users who created the session may be allowed at any time to seize control from current leaders.

Neighborhoods: Because this invention aggregates related information, it is able to create neighborhoods that consist of groups of related sites or activities, such as bulletin boards, chat sessions, CB sessions, or the like. This invention allows content and services to be attached to a group of sites. A system implementing this invention catalogues and then aggregates references into a neighborhood, e.g., all car manufacturers' sites. The system stores in a database appropriate to the neighborhood. As to each catalogued Web site or event, the system associates with each site in the neighborhood particular data, as defined by the user, the individual Web site owner, or the service provider. As an example, in one implementation the system may use a Web crawler to identify and associate sites based on their content. Thereafter the system creates relational databases to indicate which sites, bulletin boards, users, collaborative browsing sessions, etc. are related to one another. Using the browser companion, users can access these aggregated sites in order to determine other sites or information of interest to the user's present Web site, bulletin board, chat discussion, collaborative browsing session, etc.

For instance, suppose that John wishes to shop for a vehicle. John would like to visit the various car manufacturers' Web sites and view their offerings, as well as view comments from other consumers interested in purchasing a vehicle or who have used a vehicle in which he is interested. Present technology allows users to visit a Ford Web site, for instance, and to put a note or “sticky” on the Web site detailing information about a particular car or the Web site itself. However, other visitors to the Ford Web site cannot view the note left by the first visitor. John, however, would like to see those previous notes. Using the present invention, John is able to visit a Ford Web site and view notes from prior users. In addition, John is able to view notes placed on related sites. John can view notes placed on the Toyota Web site. In one embodiment, the present invention uses relational database techniques to track related groups of sites, the notes posted on those sites and the category of note (e.g., public, private to the user, or restricted to a defined user group). To do this, a system of this invention warehouses the notes and highlighting that users add to each site in a database that is associated with a particular server. A highlighted item on a Web site involves the user selecting the text of interest and clicking on that text so that the text “highlights” via the user's browser. For instance, shading or a change in background color may be used to indicate a section of highlighted text. When that particular user revisits the site or, when other users who are associated with the user that highlighted the text, visit the site, the server of the present invention retrieves the highlighted text and displays it for the visitor. The highlighted text is typically stored in a database and indexed. For instance, particular words that are highlighted are stored and then the server searches the page to build a picture of where on the browser page the particular words appear. Such a picture is necessary on a order for the server to know exactly where to highlight the text.

Using the methods and systems of this invention, users can post notes to a single or a set of Web sites or bulletin boards. For instance, suppose that a user is visiting a financial portal such as Yahoo.Com or Quicken.Com. Quicken's message board may not be as in-depth on particular stocks as Yahoo's. Using the present invention, Quicken is able to provide visitors with message board postings from Yahoo or other sites, thereby greatly enhancing the information available to visitors of the Quicken site.

Tours: With this invention, Web site owners (e.g., the Ford Motor Company, the CartoonNetwork, Disney, etc.) can offer structured tours that consist of collaborative browsing sessions limited to a single site or neighborhood of sites. Additionally, by assigning users and the tour operator selected administrative rights that authorize users different functionality, transforms tours can be turned into group moderated browsing sessions that aim to accomplish particular objectives. By way of example, a university may create a tour of a set of Web sites dealing with a particular class topic, e.g., art, that is led by a tour operator who is a professor. The professor moderates and leads the group tour. By assigning students and/or the professor different levels of rights during the tour, this invention allows the provider of the tour to manage the collaborative and interactive nature of the tour. Or, in another example, commercial Web sites may establish a site specific tour, optionally moderated by a customer service representative. Such site specific tours can be designed to provide users—including, in one embodiment, users not previously outfitted with a browser companion according to this invention—specific information, e.g., “how to” sessions, or limited access to particular persons, e.g., engineers who designed the product or celebrities who promote the site or its contents. Managing the users' and moderators' administrative rights allows providers to control the amount of interaction and collaboration allowed by the tour.

Exemplary Architecture and Implementation: A system for implementing the methods of this invention may comprise: (1) an application that plugs into, or is integrated with, the user's browser to create a browser companion and (2) a server and associated network that supports the browser companion with the necessary data and controls for implementing the functions described above. The downloadable application may be a plug in made compatible with various commercially available browsers, such as Windows IE or Netscape Navigator. Alternatively, the necessary functionality of the application may be incorporated into these or other browsers.

The present invention accordingly aims to achieve at least one, more or combinations of the following objectives:

To provide an provide an interface that lets the user trigger certain interactive features, ranging from a collaboration session with other users of the Internet, to joining a chat session, to viewing or making notes concerning the site being viewed, to various other functions described herein;

To display to the user the information related to the user's current location or activities on the Web (or other computer network);

To provide application that users may easily download and that may couple to and work with the user's existing browser.

To provide an application that identifies to a server the site, location or object viewed by the user.

To provide a system and method that allow several users to couple their browsers in order to coordinate their activities on a computer network, such as the Internet.

To provide a system and method that, upon receipt of information concerning site, location or object on a computer network being accessed by a user, returns a list of related information, including related discussion groups, notes, co-browsing sessions, or links to other sites, locations or objects.

To provide a network that communicates with a browser in order to provide the browser with information related to the user's present actions, including information such as the surfing experience or actions of another user.

To provide browser companion that communicates with designated servers that provide information related to the sites or actions of the user or information concerning a touring session.

To provide browser companion by which a user can cause an associated server to mark, highlight, bookmark, or share a particular site or object within the Internet and save that information for the user for later display.

To provide a system that creates communities and associates those communities to particular Web sites.

Other objects, advantages, and functions of the systems and methods of this invention will become apparent from reading the rest of this document and the drawings.

### BRIEF DESCRIPTION OF THE DRAWINGS

FIG. 1 is a schematic diagram showing a system that implements the present invention.

FIG. 2A is a network topology showing the processes for implementing the back end architecture for supporting the present invention.

FIG. 2B depicts an alternative embodiment of a network topology for implementing the back end architecture supporting present invention in which the alternative embodiment includes a dynamic mapping process.

FIG. 3 is a diagram showing the network topology for implementing one embodiment of this invention.

FIGS. 4A-F are flow diagrams depicting the management of collaborative browsing sessions in which multiple users collaboratively tour the Internet or a single Web site via a system implementing the present invention.

FIG. 5 is a block diagram depicting exemplary control window layouts and functionality for users taking advantage of the features offered by the present invention.

FIG. 6 is a flow diagram depicting implementation of one embodiment of the present invention in which information related to the users current activity on the Internet might be organized and accessed for display to the user.

FIG. 7 is a flow diagram depicting the process for identifying information related to the user's current activity on the Internet.

FIG. 8 depicts one implementation of the present invention by which the user's browser companion allows the user to access various visited sites during a collaborative browsing session.

FIGS. 9A and 9B shows an exemplary process by which the present invention may allow users to record private and public notes during a collaborative browsing session.

FIG. 10 depicts one embodiment of this invention by which a site-specific CB session is implemented among participants who have not previously obtained the plug-ins necessary to implement this invention.

FIGS. 11A-C depict exemplary browser layouts that are displayed to the user and by which the user may access information related to the user's location or actions as the user browses the Internet.

FIGS. 12A-H depict exemplary browser layouts by which a user may access CB session, related groups, add notes or perform other tasks allowed by this invention.

### DETAILED DESCRIPTION OF THE DRAWINGS

Terminology:

Before further describing a particular implementation of the present invention that is shown in the drawings, the following terms are explained, although more thorough understanding of the terms can be obtained by resorting to this entire document. These term explanations are not intended to be conclusive, as technology will change and skilled persons will recognize other ways to implement the same functionality.

Browser: refers to a software or firmware application that, using a communications program, contacts a specific computer that is coupled to a computer network, such as the Internet, a WAN or a LAN. The contact may be to request information from the computer or to provide the computer with information. The browser also displays the information retrieved from or to be sent to the computer. Of course, a browser can support additional functionality beyond simply contacting and displaying information received from and input to the computer network.

Browser Companion: refers to the portion of the user's main browser, or to a separate browser (e.g., a plug-in) coupled to a main browser, either of which implements the functionality required by this invention and/or displays the data retrieved by this invention for the user. The Browser Companion typically displays retrieved data in a sidebar that appears as a separate window located to one side of the user's main browser, although the location or existence of the window is not critical. The Browser Companion of this invention may be implemented as a separate browser that couples with the user's main browser or as a module of a single browser.

Chat: refers to a service, also often called IRC or Internet Relay Chat, by which users may communicate with others. A user typically initiates a chat session by starting an Internet session, selecting a channel to join, and begin typing words that are instantly displayed to other users in that channel.

Club: a group of users sharing one or more common traits, e.g., interests, hobbies, employment, organizational memberships, etc.

Collaborative-browsing: refers to allowing multiple users to initiate a session in which they collaboratively browse, navigate or tour the Internet or a particular Web site, bulletin board, discussion group, etc. therein.

Group Web Ring or Group Ring: a grouping of Web sites, bulletin boards, or other objects where a club defines the group.

Instant Messaging: refers to a chat like service by which individual users can send private, instant messages to other users, typically users who are on the first user's buddy list or in some other defined group. As members of the group log onto the Internet and initiate their instant messaging software, other members are notified.

Object: refers to a document, Web page or the URL thereof, Web site, graphic, text, animation, audio file or, video file, that the user views on a computer network such as the Internet.

Server: refers to a software module that receives and processes a request from a client module or device. The processing typically involves handling the client's request, e.g., by obtaining and forwarding relevant data. One, or multiple, server(s) can be implemented on a single platform (e.g., a PC, router, or other processor) or across multiple platforms.

Uniform Resource Locator (“URL”): Web pages accessible over the Internet are typically specified by a uniform resource locator address. As explained in U.S. Pat. No. 5,987,466, this address comprises an access method/protocol designation such as http as a prefix, a server name, and the requested document as a suffix. The server name typically includes a domain name, which may be the name of a company, educational listing, government body, or other organization that maintains the server.

Whispering: refers to a chat service that allows group members to conduct a private chat session whose contents are unavailable to other group members.

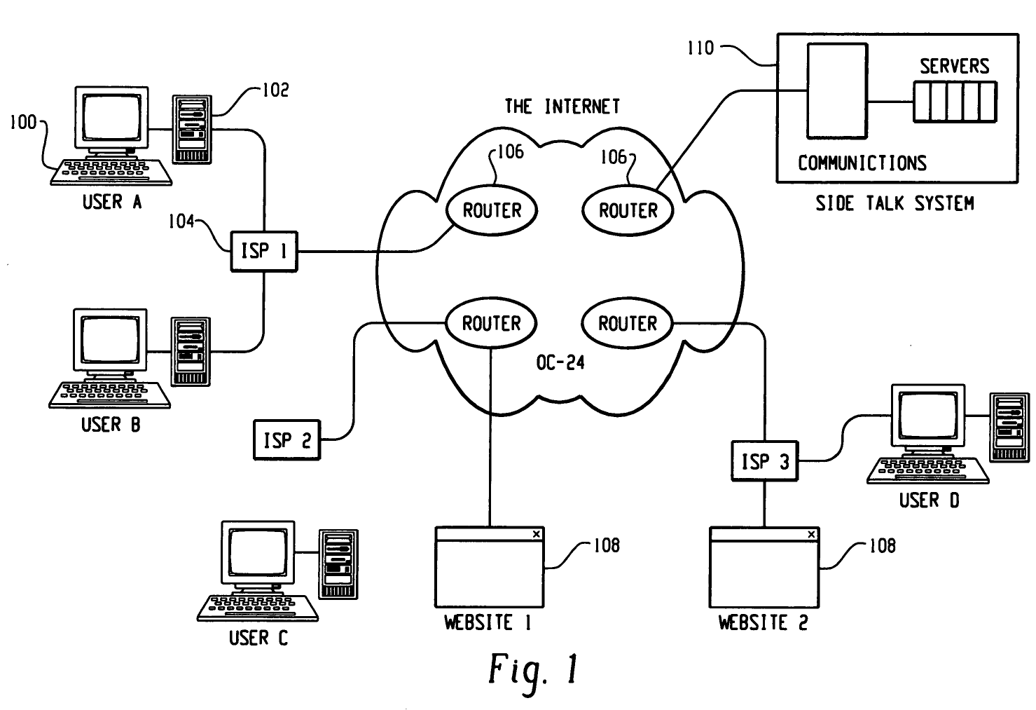

Overview (FIGS. 1-3):

The present invention provides Internet users with a browser companion comprising a Web browser plug in (or enhanced Web browser) backed by a separate server architecture. The browser companion may appear as a sidebar on the user's main browser, as a separate, closeable window within that browser, or is an accessible file on the user's Internet browsing device (e.g., PC, handheld, mobile phone, etc.). A browser companion plug-in may be configured to use the user's existing or main Web browser to provide display and interactivity, allowing the browser companion to be a small software file. The server architecture backing the browser companion uses a number of servers resident on one or multiple platforms to support the browser companion as it provides various services to users.

FIG. 1 shows an overview of a system for implementing the present invention. The system comprises a computer network, such as the Internet or the World Wide Web portion thereof, and a number of users 100. Each user 100 is designated differently, ranging from user A-D. Each user 100 is shown as having a network compatible device that is shown in FIG. 1 as a personal computer (“PC”) 102. But skilled persons will recognize that network compatible devices can be any other Web capable device, including a Palm or other PDA, a wireless Internet device such as one available from Nokia, or other Internet devices such those offered by WebTV. Each PC 102 couples through various Internet service providers (“ISPs”) 104 to routers 106 within the Internet. Using TCP/IP communications protocols, users 100 at their PCs can instruct the browsers on their PCs to retrieve Web pages or other information from the Internet. Routers 106 send Web page requests to the appropriate Web sites 108. Using Hypertext Transfer Protocol (“HTTP”), or some other acceptable protocols, Web sites 108 provide PCs 102 with the desired document, Web page, etc.

In this invention, the assignee of this application except in the site specific collaborative browsing implementation described later in this document, provisions each PC 102 with a companion co-browser. Browser companions may be downloaded to each user 100's PC 102 via the Internet from a central site 110 that has several servers and databases. Thereafter, the browser companions can communicate with servers at the central site 110 to obtain information related to each of Web sites 104 and inform the central site 110 of the user's actions when necessary to obtain the related information.

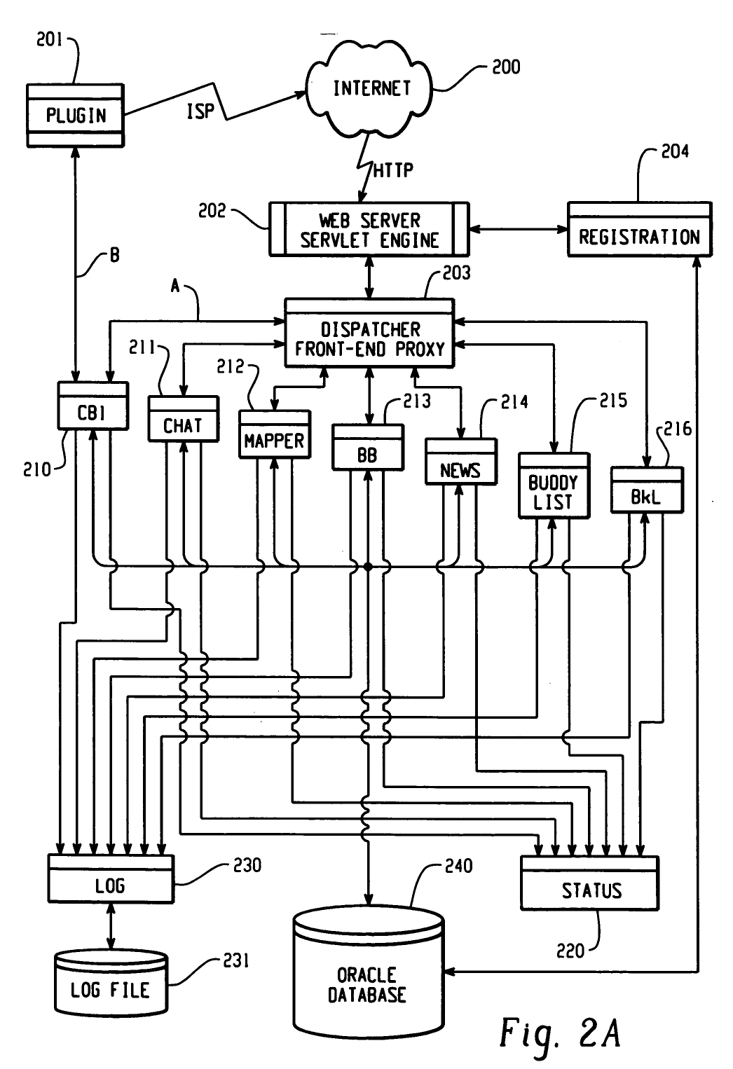

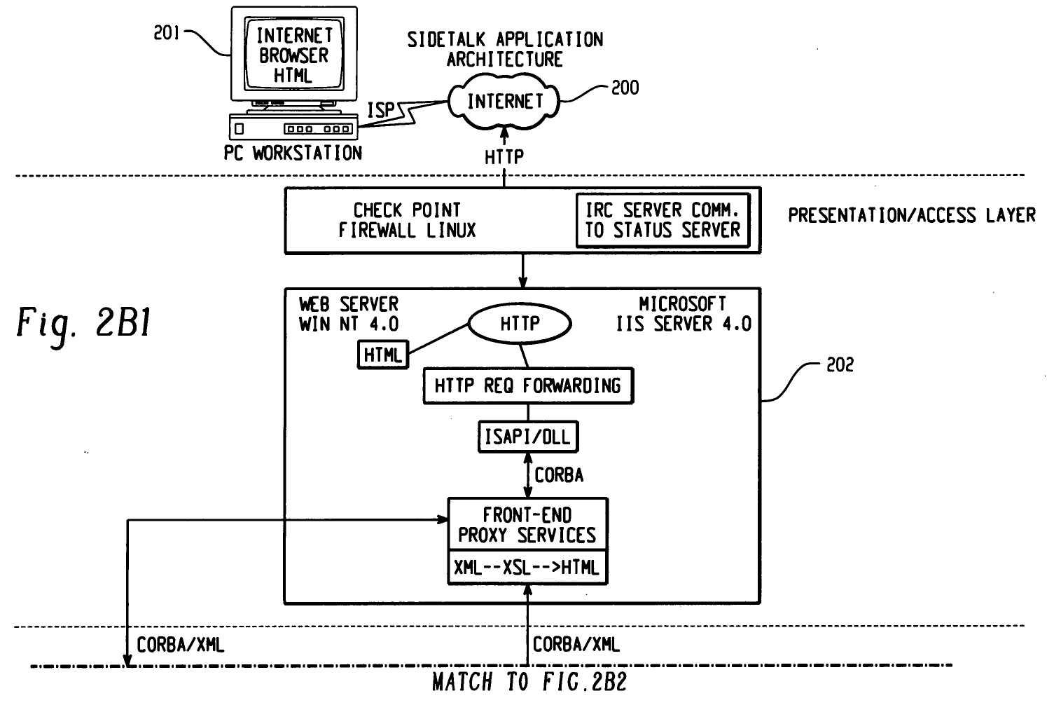

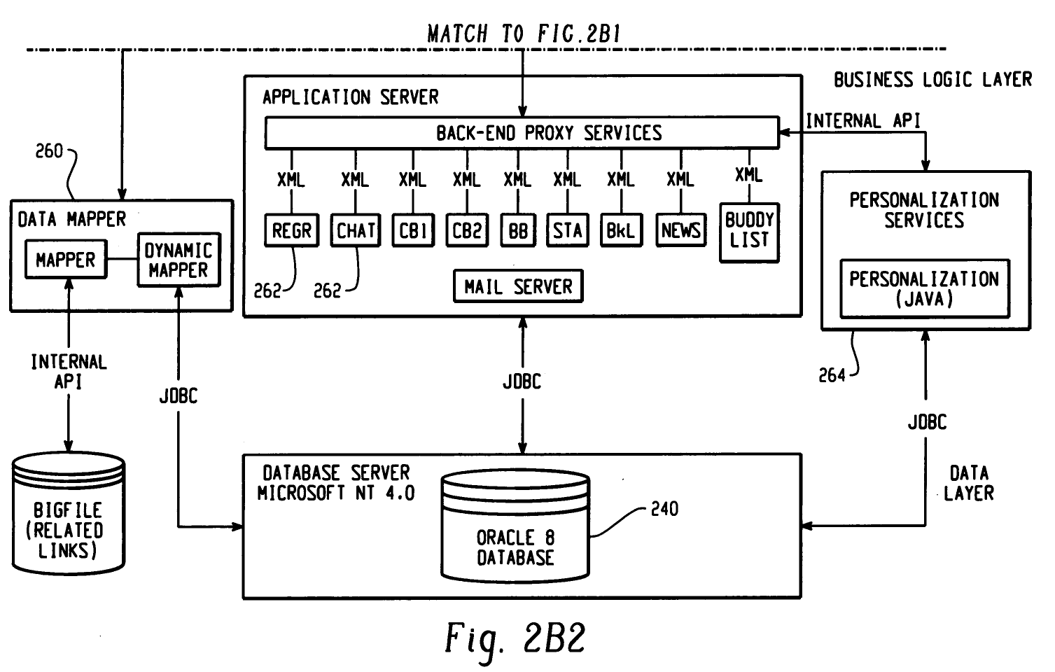

FIG. 2A shows one implementation of the back-end architecture for supporting a browser companion 201. As depicted in FIG. 2, browser companion 201 is shown as a plug-in that couples with a user's main browser. The plug-in communicates via an ISP over the Internet 200 to send a HTTP request to a Web server 202, which communicates with both a dispatcher or proxy server 203 as well as a registration server 204. The proxy server 203 communicates with various servers that support different services to 210-216. As depicted in FIG. 2, the particular services implemented in this embodiment include: a collaborative browser server 210, a chat server 211, a Mapper server 212, and bulletin board server 213, news server 214, a buddy list server 215, a back link server 216. Skilled persons will recognize that other services can be supported with the architecture of this invention. Each of the servers 210-216 for the services communicate with a status server 212, a log server 230 and a database 240. The status server 220 functions to track which users are logged in to the Internet and active. The log server 230 tracks system information such as each user's use of particular services and for each service the log server may track the user's activity on the Internet. Log server 230 may compile a log file 231 in order to track of all the data generated as subscribers implement the services 210-216. A database 240, such as a relational database provided by Oracle Corporation, supports registration and services servers. FIG. 2A shows that collaborative browser server 210 has two communication paths, Path A and Path B. Path A may be used by the collaborative browser server 210 when a user first logs into the system and initiates a collaborative browsing session. Initiation of that session may follow the typical protocol of routing the user request through Web server 202 and dispatcher 203 over Path A to collaborative browser server 210. However, in order to reduce traffic demands on the network, once the collaborative browsing session has been established, the collaborative browser server 210 may establish a direct communication Path B with the user's browser companion 201, substantially reducing the overhead traffic dispatched by proxy 203.

As shown in FIG. 2A, the system of this invention may be implemented as follows:

The user browses to a new location. Step 1.

The browser companion 201, by subscribing to the navigation event, is informed of this and sends a request over the Internet 200 to a central site, e.g., Web server 202. Step 2.

A Web Server receives the request. Step 3. Incoming requests may be load-balanced by use of a traffic director (such as Cisco LocalDirector or Linux Virtual-Server). The actual request is serviced by a Proxy software component, which may be implemented as a Web Server plug-in. A Proxy Server 202 may be implemented as a typical server running a Proxy daemon that services incoming queries. In one implementation, as seen in FIG. 2, through Web server 202, proxy 203 communicates with a Registration Server 204, which checks login information concerning the user and retrieves any preference information about the user. In one implementation, as seen in FIG. 2, through Web Server 202, Proxy 203 the Proxy server was divided into two parts—a front-end proxy comprising an ISAPI IIS plug-in, which receives the incoming request and performs CORBA requests to Registration 204, the Mapper 212 and, optionally, a back-end proxy component. The Proxy server 203 may use the MSXML library to optionally transform the XML responses into HTML. In any event, the Proxy server 203 contacts the Services 210-216, also using CORBA, and returns the resulting XML to the front-end.

The Proxy server 203 connects to a Registration server 204 (step 4), checks the login information and retrieves any user preference information, which includes: user profile date (name, nickname, email, password), demographic data (age, gender, income) buddy lists concerning the user.

The Proxy server 203 then connects to the Mapper server 212, and asks it for a list of active services and a list of related links. Step 5. The list of related links forms a neighborhood.

The Proxy server 203 then connects to the Services 210-216 (in parallel, if desired) and retrieves context-based information (such as which discussions are active in the neighborhood associated with the site being visited, whether and which chat rooms on related topics are open, etc.) Step 6.

The Proxy server 203 then converts the data to HTML (step 7), if necessary, and returns the result to the user's browser 201 (step 8), to be displayed in the browser companion, which may appear as a sidebar adjacent the user's main browser window. Step 9.

FIG. 2B shows an alternative implementation of the architecture and processes shown in FIG. 2A. Generally, the system of FIG. 2B was designed for a Windows NT environment, whereas the system of FIG. 2A was designed for a Unix type environment. The system of FIG. 2B additionally includes a data mapper server 260 that can use one of two processes, the mapper function or a dynamic function. Both of these processes are explained in more detail below.

Exemplary System for Implementing the Methods and Systems of This Invention:

An embodiment of this invention may by implement by providing a browser companion, such as via a plug-in that facilitates access to browser companion information and services provided by back-end architecture. In one implementation, the browser companion may be a client plug-in compatible with already available Internet browsers. For instance, the plug-in for Microsoft's Internet Explorer browser may be a WIN32 DLL that can be implemented as an embedded sidebar. The resulting browser companion requests content from the supporting servers after the browser main window loads a page. Thus, when a user browses to a new location on the Internet the browser companion subscribes to the navigation event record formulated by the user's main browser and is thereby informed of the user's action. The browser companion formulates a query to the back-end architecture supporting the browser companion. The query may be formulated in a protocol that uses HTTP and the browser companion may be configured to receive the result in HTML or XML. The query contains (a) information concerning the user and (b) information describing the user's action, e.g., accessing a particular Web site (in which case the URL for the site may be provided) or a particular service, such as a bulletin board or chat.

The Mapper server 212 aims to provide the user with information relevant to the user's present action. In a first embodiment, the Mapper server 212 translates the URL the browser companion 201 provides into a document ID that the Mapper server 212 uses to search for related information. Related information can be related or featured links, e-commerce pointers, CB sessions, notes, bulletin boards, etc.

Alternatively, in yet another and different embodiment the Mapper server 212 may provide the user's browser companion 201 with information such as related links, newsgroups and backlinks derived from an automated searching service performed by either another server process or by a commercially available service. These automated services “crawl” the Internet to determine which sites, newsgroups, etc. are relevant in subject matter and should be aggregated into a neighborhood or otherwise associated with a particular site, such as the one being viewed by the user.

A Registration server 204 may be provided. It can be used to track user information and preferences such as via various linked tables storing customer information. Likewise, a Chat service may be implemented as collaboration between the Collaborative Browsing server 210 (for session state), the Status server (for locating users), an IRC server (implementing the Internet Relay Chat protocol) and a chat applet. Although it is using an applet, the actual user interface uses HTML and JavaScript. A Collaborative Browsing server 210 keeps track of Collaborative Browsing sessions and provides the Co-Browsing user interface and application logic. The Bulletin Board server 213 may handle bulletin board information as well as personal notes and highlights, coupling to the database 240 to store messages. The Status server 220 tracks the location of users and chatters in order to provide neighborhood attached chat rooms or neighborhood instant messaging. A Groups service (not shown) provides group management and book marking functionality. A Commerce server, which may be stand-alone or implemented as part of the Mapper server 212, retrieves featured links and partner content for presentation in the user's Commerce tab.

The Proxy server 203 may communicate with the Registration, Mapper and Services servers 204 and 210-16 using CORBA and XML. Services provided via the back-end server architecture may return XML, which can be converted at the Proxy 203 or at the client (if the client has such capabilities, e.g., MSIE 5). XML is converted into HTML and JavaScript by use of a stylesheet (XSL). Services 210-216, which require database access, may use protocols such as JDBC and/or SQL to communicate with an Oracle or other appropriate database 240. The Chat server 211 uses IRC (Internet Relay Chat). Any number of programming languages may be used to implement this functionality on the required servers. For instance, C++ and Java may be used, although C++ has been found particularly appropriate when performance is critical (e.g. part of the Proxy), or when accessing indexed flat files (e.g. Mapper). Java is used when ease of development is more important. The Web servers and the front-end part of the Proxy server may run on Windows NT using IIS. The Mapper, Registration and Services daemons 204, 210-216 may also run on NT, UNIX, or they can be coded in portable C++ and Java to be portable to other operating systems like Solaris or Linux. A database, such as those provided by Oracle, may be used and provisioned to run on Windows NT, although the databases can be selected from other providers to run on other operating platforms.

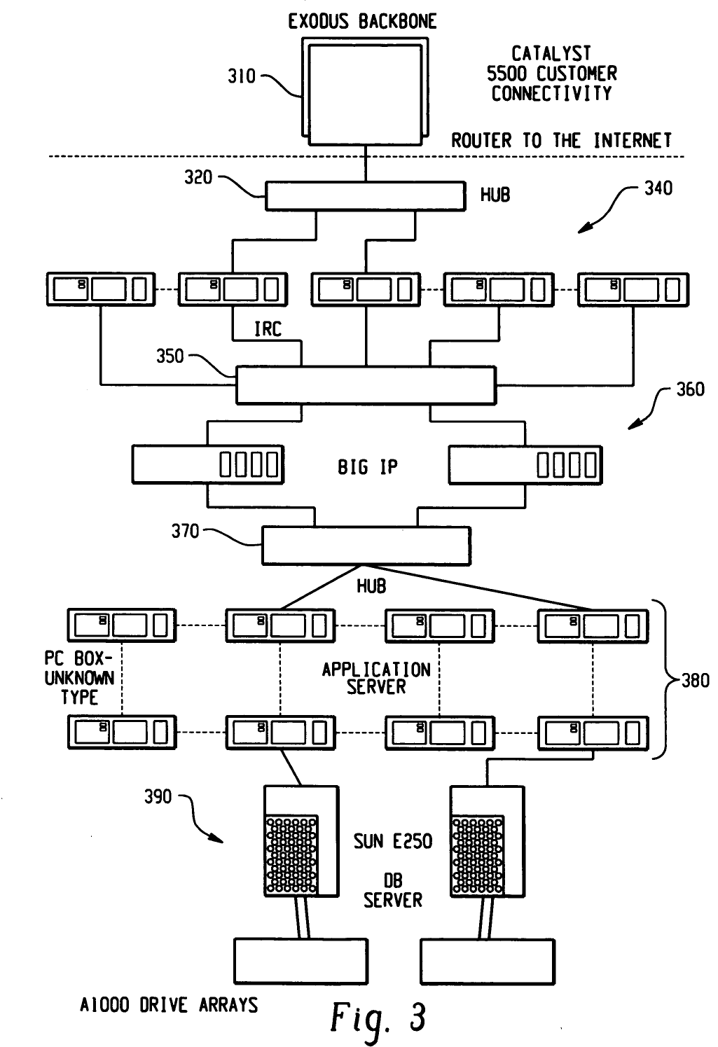

FIG. 3 shows a particular hardware implementation for the system shown in FIG. 2. A router 310 couples a hub 320 to the internet. Hub 320 connects to a firewall and IRC servers 340. A second hub 350 couples to two big IP databases 360 that have necessary Internet routing tables in order to control those databases. One of the two IP databases 360 is for failover purposes. A third hub 370 mediates between the IP databases 360 and the application servers 380, which couple to relational databases 390. Skilled persons will recognize that the architecture shown is for a Windows NT operating environment and that other implementations like Unix require different implementations.

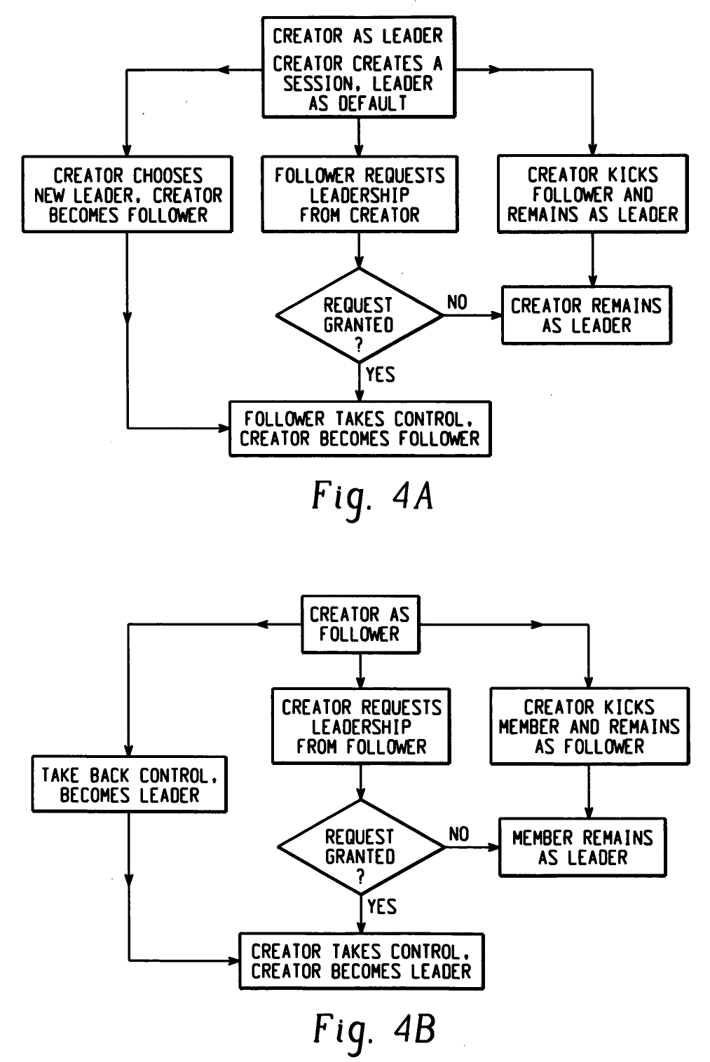

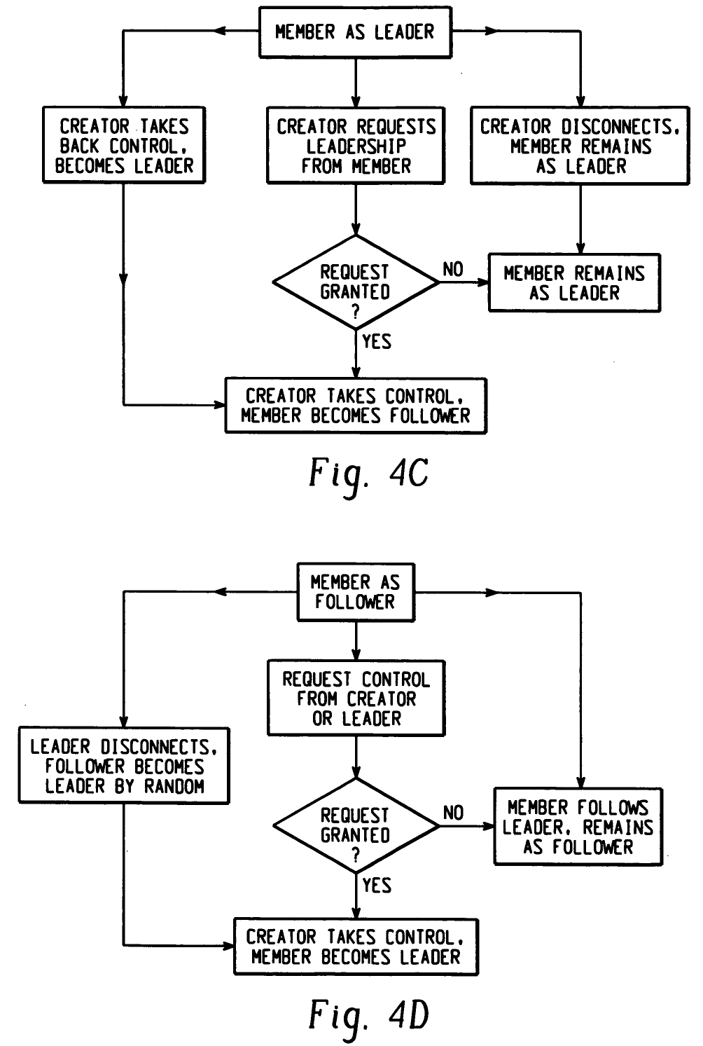

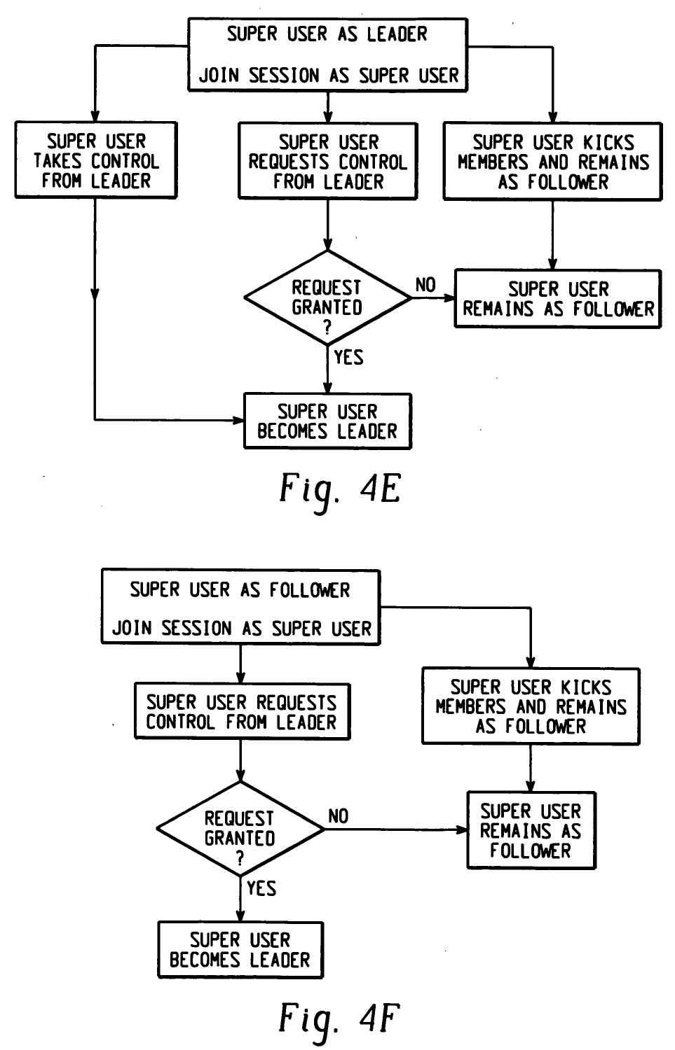

User Interactivity Features (FIGS. 4-6):

Collaborative Browsing: This invention allows multiple users jointly to navigate a computer network like the Internet, and particularly the Web. During the collaborative browsing session, users may communicate with one another, either as part of their browsing experience or to negotiate control of the browsing session. Depending on the user's particular status, a different bundle of administrative rights with respect to the conduct of the collaborative browsing session is assigned. For example, in a preferred embodiment, users are assigned a status and particular administrative rights as depicted in Table I below:

TABLE I

| | Invite | Whisper | Request | Give | Take | Kick |
|---|---|---|---|---|---|---|
| Creator as Leader | X | X | | X | | X |
| Creator as Follower | X | X | X | | X | X |
| Member as Leader | X | X | | X | | |
| Member as Follower | X | X | X | | | |
| Super User as Leader | X | X | | X | | X |
| Super User as Follower | X | X | X | | | X |

Table I shows that in this embodiment, users are allocated into one of three classes: creator (the user initiating the session), member (a user participating in the session) and super user (one member designated by the creator to have certain administrative rights). Within the three classes, there are two main roles—either the user is a leader or a follower. A selected subset of administrative rights (e.g., Take, Invite, Whisper, Request, Give, Kick) are assigned to users based on (a) their class and/or (b) their role. There is only one leader at a time. Leadership can be traded among the three classes, however, some of the classes enjoy more administrative rights or privileges than others.

For instance, a creator who has “Given” away leadership maintains the right to automatically “Take back” leadership or to “Kick” disruptive members from the session. In some instances, users may be reassigned to a different class. By way of example, a creator can “Give” the “creator” status to another user in certain situations e.g., when the creator must leave the session, but desires for one user to retain control of the session and maintain the ability to kick or lead the session appropriately. An administrator can create super users in the background to provide users having a moderating role.

FIGS. 4A-4F depict implementation by the users of various rights granted to each. Thus, for instance, FIG. 4A shows the rights that a creator/leader (creator as a leader) has in choosing a new leader, responding to a request from a follower for leadership, or kicking followers from the CB session. FIG. 4B shows the rights that a creator/follower (creator as a follower) retains even as a follower. Thus, the creator/follower can Take or Request control or Kick members. FIGS. 4C and 4D show a member's rights—which are not as robust as the creator's—as leader (FIG. 4C) and follower (FIG. 4D). FIGS. 4E and 4F depict the super user's rights as leader (FIG. 4E) and follower (FIG. 4F). A super user is a member who shares the attributes of a leader and follower.

Skilled persons will understand and recognize that the present invention may be adapted in other ways to provide user's other administrative rights. By way of example, rights to initiate certain services could be granted to a leader or super user. For instance, in future applications, a user may want to authorize an IP telephone conference call with all or some of the session members. Provided that the leader identifies a charge account, the system of the present invention may pre-authorize the members to do so and provision that right or others in the same manner as described above. Additionally, this invention supports the provisioning of new roles or classes for participants. By way of example, a “mediator” role can be created in which a mediator member will automatically receive all questions or comments from other members. The mediator could be the only person allowed to communicate with a new class of user, a “Guest.” In practice, the Guest may be a teacher, company executive, celebrity, etc. who is answering questions posed by other participants and/or leading portions of the CB sessions.

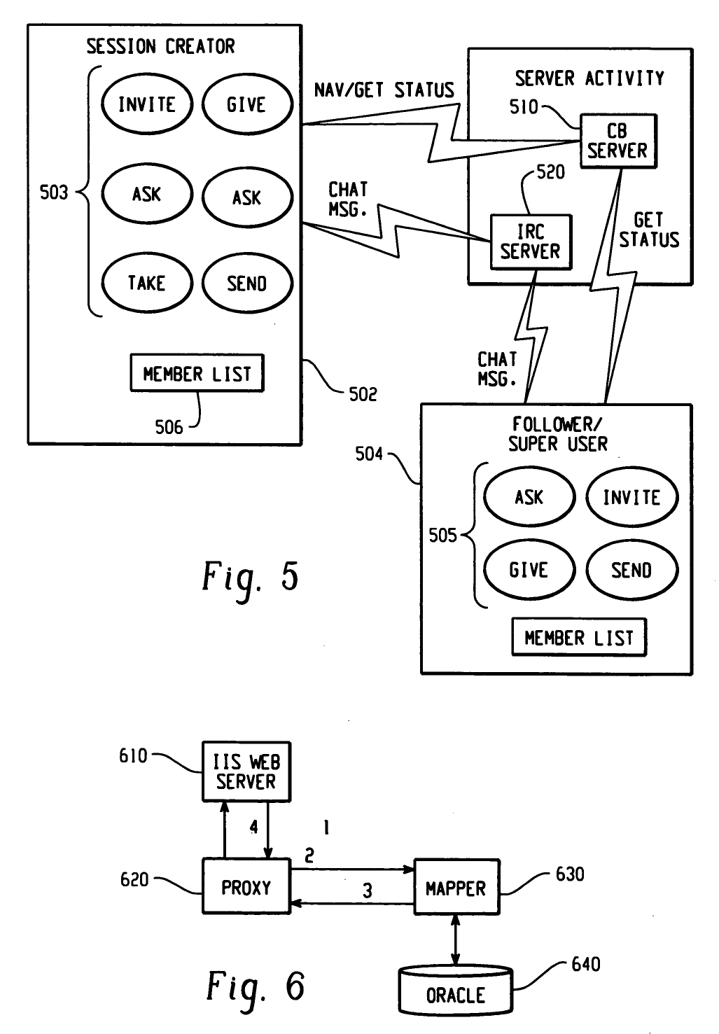

Initiation of a CB Session: FIG. 5 is a simplified representation of user initiation and interactive control of a CB session. To initiate a collaborative browsing session, a user can create a session, e.g., by clicking on a Create New Session link or buttons. The user designates a Collaborative-Browsing (CB) session as either public or private. The server will create a default name field auto-populated in the new session. The pre-populated session name is <User's nickname> Session. The user has the option of re-naming it. Any user can see and/or join a public session. Only the creator of a private session and the users he/she invites can see and/or join a private session. The user adds others to the session by inviting people from a Buddy List or by inviting other participants, usually by referencing nicknames or e-mail addresses.

After initiation, the creator's browser companion may choose a particular CB server 510, routing a “create request” to that server 510. If the session creation was successful, a request to open the CB control window is made to the server. If the session creation failed due to a problem with the assigned server a new attempt is made to another server. In cases where session creation is unsuccessful, then a user will receives an error message.

In the implementation shown in FIG. 2, the event record may be forwarded to the log server 230 for logging in file 231. The CB server 510 creates an event record for each collaborative browsing session. The CB server 510 populates various fields in the event record with information about the CB session, such as a name field, public or private session option, and an invitation field. A new instance of a session object is created on the server side and added to the data structure (such as a hash table) keeping track of current sessions. Session creation results are passed to the client. The session object may have the attributes set forth in Table III below. As skilled persons will recognize, other session control features may be readily adapted to this invention, including features modelled after IRC session control.

TABLE II
Session Object Attributes

| Field | Description |
|---|---|
| ID | Concatenated by type and the chosen name excluding certain |
| | special characters |
| Name | Specified on the new session form |
| Creator | Nickname of the user creating the session |
| Leader | Corresponds to the current leader |
| Previous | Keep track of the previous leader as leadership changes |
| leader | |
| Started | The time the session was started |
| time | |
| State | Active/pending. It will be pending until somebody joins, then |
| | becomes active |
| List of | List of member or members who have nicknames joined the |
| members | session |
| List of | List of user session ids (sessionid = userid + windowid), one |
| User | entry for each join |
| session ids | |
| List of | List of nicknames of the users invited to the session |
| invitees | |
| Current | Includes the URL, current frame information and sequence |
| navigation | number |
| Lists of | Contains the current list of “request for control” that has to be |
| requests | passed to the leader |
| for control | |
| Last | Timestamp for the last navigation in the session |
| active | |

Assuming a first user has successfully created and joined a CB session, other users can join in, e.g., by clicking a link in their browser companion sidebar. A user can join a private session by accepting an invitation displayed to him by a popup window or by clicking a link in the sidebar. The user receives an error message if the user tries to join a session the user has been kicked from. For each invitation, if the invited user is not a member of the session, then (a) the user's nickname is added to the invitation list and (b) a new record, e.g., a Member Instance, is created and an Invitation instance is created and added. When a user joins a CB session, the user's nickname and user's session id (userid+windowid) are added to the members list. The member is then added to the list of user session ids. The user's session id is added to the list of session ids. If the user is already a member, the nickname is not added. Each window has a window id that is unique. The CB server passes results from this join session process back to the client and all pending invitations to this session are removed from the CB server.

A CB control window 504 opens when a user joins a session and communicates between the browser companion and a CB server. FIG. 5 shows that the joining user is assigned to the “super user” class and provisional with various rights 503. The control window has a mechanism to retrieve session status from the CB server. A CB applet that may be similar in structure to a chat applet can do this and is then loaded and initialized. The chat applet is loaded and initialized and a connection to an IRC server 520 begins. Each CB Session will has its own chat room. The CB session id is used as the room name to ensure unique rooms. Users are designated a IRC nickname. If the nickname is in use (which happens if the user has several connections to the IRC server 520), the nickname will be appended with a random number. Member lists are populated with data from the IRC server 520. For display purposes, nicknames may be trimmed.

The CB applet is loaded and initialized and sends the status requests to the server. Each user has a button for each subset of actions such as Request, Handover, and Take control, depending on the user's role (See Table I). If the creator invites friends using a new session form, invitation requests are sent and request results are posted in the invite box. If an error occurs while joining a session, the control window closes and displays an error message.

FIG. 5 depicts exemplary layouts for control windows displayed to a leader, creator, user or super user during a CB session. Members of the session are listed in the member list 506. The leader is marked with a leader icon. The follower is marked with a follower icon. The user can view the conversation in the chat session. The user participates in the conversation by entering messages in the Send box 503. Participants receive all messages except whisper messages, which are messages directed to a restricted set of other users. A user can whisper to another user, or multiple other users, on the member list by clicking on the name(s) from the member list and entering the message in the Send box. Whispers are only displayed to the selected users' chat areas. A user can open his buddy list by clicking on the Buddy link. The user can add buddies to his buddy list by selecting the member's name and clicking the Add link. The user can invite friends by entering nicknames and/or e-mail addresses in an invitation box.

The leader can enter URLs in the URL box to navigate the session The leader can transfer control of the session to other users by selecting a name from the user drop-down box. The follower can ask the leader for control by selecting the Ask button. The creator can regain control by selecting the Take button. The creator and super user can kick users out of the CB session at any time. Selecting the member's name and clicking the kick icon, a member can be kicked from a session.

The control windows communicate, via the users' respective browser companions, over the Internet to an IRC server and a CB server 210, e.g., servers 210, 211 in FIG. 2. During a CB session, whenever the leader changes locations or otherwise navigates, the followers' browsers must be informed. To do so, their control windows routinely receive updates, which include data such as the leader's location or status information like the identity of any new, invited, asking, or kicked users. Thus, both the leader's and followers' control windows may send status requests to the CB server and are returned a result that includes the leader's URL and identity, who has asked for control, who has been kicked or invited, and who are members. Alternatively, rather than using status requests, skilled persons will recognize that open connections can be maintained between an IRC server and client windows or the IRC server can send state change data when it occurs. However, by using the IRC server, status requests can be piggybacked onto the normal chat messages, with the Proxy server and/or browser control windows simply discriminating among the various messages to pick out chat, status or return messages. In any event, the control window periodically queries a CB applet for the current status of the session using a status request. The chat frame runs the status request for the IRC messaging. A keep Alive process aims to ensure that the session stays alive as long as a leader is present and that there is activity, either conversational or navigational. Leaderless sessions with no active followers are terminated. The control window asks the CB applet for the status of the session. If status isn't OK (e.g., because of a down server of network connection) then wait until status is OK again. If status is KICKED, the control window displays for the user a “Kicked” message (e.g., “you have been Kicked from this collaborative browsing session”). For leader users, if other users have submitted Ask for Control requests, the control window prompts an appropriate popup message. Likewise, for all members, status changes such as Member Changes or Leadership Changes prompt updates to the UI (see Information) and a message is displayed if needed. The user's main browser thereby can receive via the browser companion and various servers, appropriate URL changes, frame URL changes, frame name changes and frame index changes.

One aspect of this invention is that a single subscriber can participate in multiple CB sessions, each of which will have a control window. The control windows are used for both the CB sessions and chat sessions. By using Keep Alive status requests, this invention ensures precise information is delivered as to whether a process remains running. The CB applet sends status requests to the CB server every <X> seconds. The CB applet stops calling the server if a Keep Alive message is missing. The control window sends two kinds of Keep Alive messages to the CB applet. Keep Alive messages sent to the CB applet by java script remain; Keep Alive messages for the chat frame come from the main loop that handles the IRC messaging; Keep Alive messages for the CB frame comes from the main CB loop. The CB applet will check the last time it got keep alive from the chat and the CB. If it was longer than a predetermined time (although other triggers, such as predetermined attempts, can be used), the CB applet will stop sending status requests to the server. If Keep alive starts again, the CB applet will start the server requests again. The keep Alive process runs to ensure that sessions without leaders or activity, such as chat or navigation, are terminated.

TABLE III
Session Status

| Event | Description |
|---|---|
| Navigate | Occurs when a leader selects another page within a Web site, |
| | or leads the group to an entirely different Web site. |
| Join | Occurs when a user joins the CB session. |
| Leave | Occurs when a user leaves the CB session voluntarily. |
| Kick | Occurs when a leader or superuser kicks or removes a user |
| | from a CB session. “Kicked” users are barred from joining |
| | that CB session. |
| Ask for | A user who desires to lead the CB sessions asks for control. |
| Control | |
| Take | A creator or super user may, depending on their rights, take |
| | control of the CB session without the permission of the |
| | present session leader. |
| Invite | A creator or member participating in a session may invite |
| | other users to join. Depending on whether the session is a |
| | public or private session, the invite rights may be limited to |
| | a list of names. |
| Confirm | An invited user indicates whether he will join the session, |
| | after which the user's browser sends a confirmation |
| | indicating whether the user will or will not join. |

When the server gets a status request, it returns the current status of the session by including the following: current URL; frame; frame name; frame index; sequence number; leader; members; or control request.

Actions During a CB Session: Navigate Event: On the client side, when a user navigates with their browser, a default request is sent via the browser companion to the CB server. The URL the user views is part of the default request, which thereby informs the CB server of the user's location. In a frame navigation that occurs within the Web site being visited, the frame URL, frame name and/or frame index are all part of the default request.

The server checks to see if there is a session associated with the user session id (userid+windowid). If a session is found, it is set to the current session. If a current CB session is found, for a follower's browser companion the user session object will be updated with the current location for this user. If a current CB session is found, for the leader's browser companion, the past URL is used to set the current URL for this session. In a frame navigation, the frame URL, frame name and/or frame index are set for the CB session. For each navigation, a sequence number is increased by 1 and a user session object is updated with the current session location. A list of CB sessions are returned to the client, which displays the ongoing CB sessions that are associated with a site or neighborhood of sites presently being visited by the subscriber.

Ask for Control: When a user seeks control, the browser companion sends an Ask for Control request to the CB server. The user who sent the Ask for Control request, receives a confirmation message. Meanwhile, the CB server identifies the current leader and the next time the leader's status applet (see CB applet status call) sends a status request, the request for control is picked up and removed. The Ask for Control request may be shown on the leader's browser companion, e.g. as a popup message with an option of handing over the control. The leader can deny or grant a request for control. If the leader grants the Ask for Control request, the leader's browser companion forwards a Handover request to the server. A message is sent back to the client to inform requesting user that the request has

Certain server designs can be implemented to minimize the load on the system for supporting this functionality. For instance, if the user has already asked for control and been denied within a certain threshold time, the request will be ignored. Skilled persons will recognize other architecture that can minimize resource usage across the system.

Handover: The leader can handover the control by (1) selecting a member from the drop-down box and clicking the hand over link or (2) granting a “request for control” as described. The old leader sees the new leader marked as leader of the session. The new leader will see the changes as soon as his CB applet does the next status request. A popup message will alert him of his leadership. Other members see the leadership changes as soon as their CB applet updates the next status requests. The control windows are updated to reflect the leader change.

The CB server checks to make sure the new leader is still a member in the session. If the new leader is not a member (e.g., if he just left the session or the drop-down box had not yet updated), then the handover message will be ignored and the old leader handover list will remain the leader. If the new leader is a member, the server transfers leadership. The nickname of the old leader is saved as “previous leader”.

Take Control: The creator of the session can regain control by clicking on the Take link. The creator will now see himself as the new leader. The old leader will see the leadership changes as soon as his CB applet updates status request with a result. A message alerts him that the creator has gained control. The other members will see the leadership changes when their CB applet updates. The control windows are updated to reflect the leader change. When a Take request reaches the server, the server verifies the user is the creator of the session, and sets the user to be the leader.

Kick: When a user is kicked from a session he cannot reenter the session. The leader or a super user must confirm kick action by clicking OK on the popup message box. When the CB applet of the kicked user gets the kicked status, the control window is closed. A kicked confirmation is displayed to the user. When a user is kicked out of a session, other session members may receive a notification message.

The kick request is sent to the server, where the user will be removed from the session, added to the list of kicked users, and if the kicked user was the leader, a new user will be assigned.

Invitation (Inviter): A user can invite friends to the CB session by entering ST nicknames or e-mail addresses in the Invite box. When an invitation request is sent to the server, the server checks the following characteristics of invitees:

Validity: The server checks to see whether the user is a valid user (e.g., has a browser companion of this invention, has paid any service fees, etc.) If an e-mail was entered, the user will be searched by e-mail, otherwise by the given nickname. If the user could not be found, an error message is sent back to the client with an option to send an email invitation to the user.

Session Status: The server checks whether the invitee is already a session member and confirms the invitee was not previously kicked from the session. If the user is already invited or kicked, an error message is sent back to the client. Assuming the user can be invited to the session, a new invitation instance is created for the invitee with inviter's nickname, reference to the session object and time of invitation. The invitation is added to the invitee's list of invitations.

Invitation (Invitee): As soon as an invited user navigates with the browser companion his invitation has been picked up and deleted from the invitations lists. The invitation is displayed to the user. The invitee may get the invitation as a popup with information about a session, such as session name, describing the Inviter and when the invitation issued. If a friend is not found, the Inviter is given the option of sending invitation e-mail to the friend. Every friend that was found will get an invitation by a popup message the next time he/she navigates. A message lets him join the session (see Join) or declined the invitation (see Confirm). The email invitation provides a mechanism to become part of the system and then be able to join the session.

Confirm: An invited user receives a message. If the user declines the invitation by clicking Cancel, a confirmation request is send to the server. When the server receives a confirmation request, the corresponding invitation will be removed from the invitation list. The inviter may be notified that the invitation was declined.

Listing of Sessions: For each navigation a user does with their browser, a “Get” request passes to the CB server. This means that the CB server has to prepare a list of CB sessions to be displayed to the user, such as in the browser companion or in the main browser window. With each Get request, the URL (among other information) passes into the CB server. The CB server goes through the complete list of current CB sessions. A session will be listed if the session is public; the session is private and the user is a member of the session; or the session is private and the user is invited to the session. The CB server compares the user's present location with the neighborhoods associated with that location. The CB server then determines which sessions are currently in the neighborhood of the page site or object that the user is accessing. Those sessions are then displayed to the user. For each session, the id, name, type, #users, and current URL is extracted. The session list is returned to the client. The user's browser companion will display the listing of the current CB sessions received from the server using the Name, type, #users, current URL. Links may be displayed in a “join a session” sidebar; the links cause the browser companion to initiate a Join function with the session id.

Pause: This invention also allows CB session participants to pause the session and attend to other tasks, browse elsewhere, etc. During Pause of the session, the CB session participant disconnects from the session, although the IRC chat connection remains open. This allows the chat to be maintained. Additionally, a thumb nail (e.g., a small picture window that may be expanded) view can be provided (e.g., in a sidebar, popup window or the like) of the location of the other participants.

During Pause, the paused user's browser companion does not display the CB session information. The control window can be disconnected from the CB server to accomplish this. Alternatively, the user's browser may simply set a flag to prevent the main browser window from displaying CB session information such as the leader's Web page. Thus, in pause condition, in this method, the paused user's browser continues to receive all of the information concerning the ongoing CB session, however, that information is simply not displayed to the user. When the user wishes to rejoin the session, the flag that prevented the main window from displaying the leader's location or action is undone. The control window then updates the previously paused user's main window with the latest URL, action, displays, etc., based upon the returns from the servers.

Related Information Display During Browsing (FIGS. 6-8):

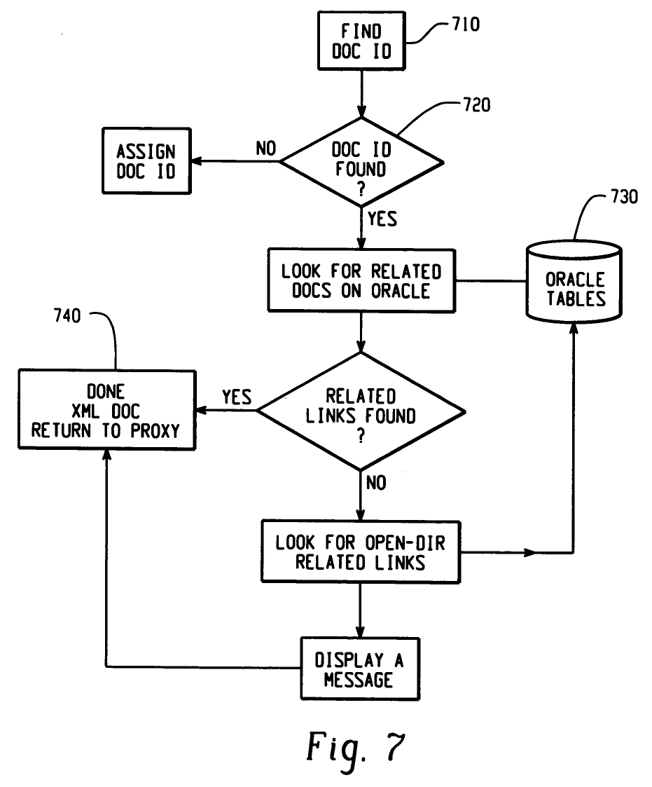

FIGS. 6 and 7 depict the processing used by one embodiment of this invention to support supplying information related to the user's present site of interest.

When a user browses to a new site from an ongoing CB session, the user's browser companion subscribes to the navigation event and informs the central site. The information includes a request for site related information and the results are returned to the browser companion for display. If related links or other information is not found, a message notifies the users that related information was not found in the URL during a browsing session.

As seen in FIG. 6, at the central site, a Web server 10 receives the URL request and services it via a Proxy Server 20, which is also the Web Server plug-in. The proxy 20 handles browser requests and routes traffic to (a) related links or (b) in other implementations such as shown in FIG. 2b, a back end proxy. The Proxy Server 20 queries a Mapper Server 30 for a list of related links or other related information (such as related bulletin boards or related on-going collaborative-browsing sessions) to appear in the URL while the user is browsing. The Mapper Server 30 may send the related links request to a Dynamic Mapper for dynamic searching (as in FIG. 2B) or query database 640 directly. At database 640, the user's present URL is compared to a list of stored URLs to determine what information, if any is associated with the URL the user presently is visiting. Table IV below provides representative examples:

TABLE IV
Database Links

| User's URL | Related Information |
|---|---|
| www.stones.com | Links: www.therollingstones.com; Bulletin Boards; |
| | CB Sessions; Stones E-Tour; Notes: Check Public |
| | Note File; |
| www.ford.com | Links: www.toyota.com; www.cars.org; |
| | www.carsdirect.com; Notes: Check Public Note File; |
| | Bulletin Boards |

In any event, when a user activates their main browser to visit the Ford Web site, the Web server asks the database for the Ford URL. The database checks whether the Ford URL has related information tagged to it, returns both the Ford URL and related links such as the Toyota, Honda or Daimler-Chrysler URLs. As the user waits for the server to download the Ford Web site to the user's browser, the Web server checks for (1) related link URLs (e.g., the Toyota, Honda or Daimler-Chrysler Web sites) or (2) neighborhood-specific notes. Another server, such as the bulletin board server, obtains the particular user's personal notes attached to that site. If such notes are found, those notes are also displayed to the user's browser.

There are a number of ways to associate the user's present URL with the related information. FIG. 7 shows an exemplary process how to identify related information linked to a particular object on the Internet. For instance, the URL can be translated to a particular identifying tag, such as a document ID. A table can be provided with a correlation between document IDs and URLs; new document ID are created when new URLs are checked. See Steps 710, 720. In one implementation of this technique, if DocID for an URL is not found, a Mapper Server then converts the URL to 64 bits DocID numbers and divides into HostID (32 bits) and PathID (32 bits). A second table can be provided that associates one document ID with other, related document IDs. See Step 730. In addition to URLs, the first table can be assigned document IDs relating to things other than URLs, such as bulletin boards, CB sessions, etc. as indicated in table IV. In any event, when a user goes to a particular site, the user's control window pings the database for the related links based upon the user's URL. For search efficiency, the database converts the user's URL to a document ID and does a look up. If DocID is found, a Mapper Server accesses the database 730 tables for matching Doc numbers for Related Links pursuant to standard algorithms or relational database techniques known to those skilled in this field. If a result is returned e.g., via XML (Step 740) to the proxy server, the result will contain the information related to the user's present URL.

The table of related information may be populated in a variety of ways. For instance, the user, an administrator of the Web site the user is visiting, or the administrator of a system implementing this invention may manually enter the related information. Automated methods may be used to populate the related information databases. Skilled persons may be aware, for instance, of the open directory project, by which a consortium of individuals that surf the net record different URLs to different categories in an effort to create a comprehensive Web directory. The related information databases may be populated by coupling to the open directory project site (www.dmoz.org) to obtain files containing categories and related URLs. Or, in another embodiment of the present invention, a Web crawler may determine related links by visiting and classifying various sites. As seen in FIG. 2B, a data mapper 260 can include not only a Mapper server 730, but also a dynamic mapper server. If Related Links are not found through open-dir search, the dynamic mapper server may implement in real time a crawler function (i.e., a search engine for related links). When related links are found, the dynamic mapper server then returns the XML to the Proxy, which then converts data to HTML for return to the user.

Alternatively, before accessing tables populated with the above data, the invention allows the Mapper server to first check whether “sponsoring” entities or partners desiring to implement this technology for their particular Web site have specified the related information they wish to have displayed to the user. For instance, if a conglomerate such as Citicorp implemented this technology for its Web sites, it may display to the user the Web site for each of its lines of business, e.g., security sales, insurance sales, banking, etc. Similarly, CNN may want to manually enter related site information so users visiting its sites are guided to other, related sites owned by Time Warner. Or, companies such as Ebay or Yahoo that have partnerships with others may display those partners' sites as related. These features are particularly useful in implementing the E-commerce functionality of this invention.

In yet another embodiment, rather than first checking whether a particular URL being visited belongs to a sponsoring entity, the architecture can be such that another process checks the attributes of the user—e.g., whether the user is coming from a particular Web site or part of a particular group. Related information can then be displayed based on the user's attributes, rather than the user's location within the Web. Providing related information based on attributes may conserve system resources and also allows additional flexibility in displaying information of interest.

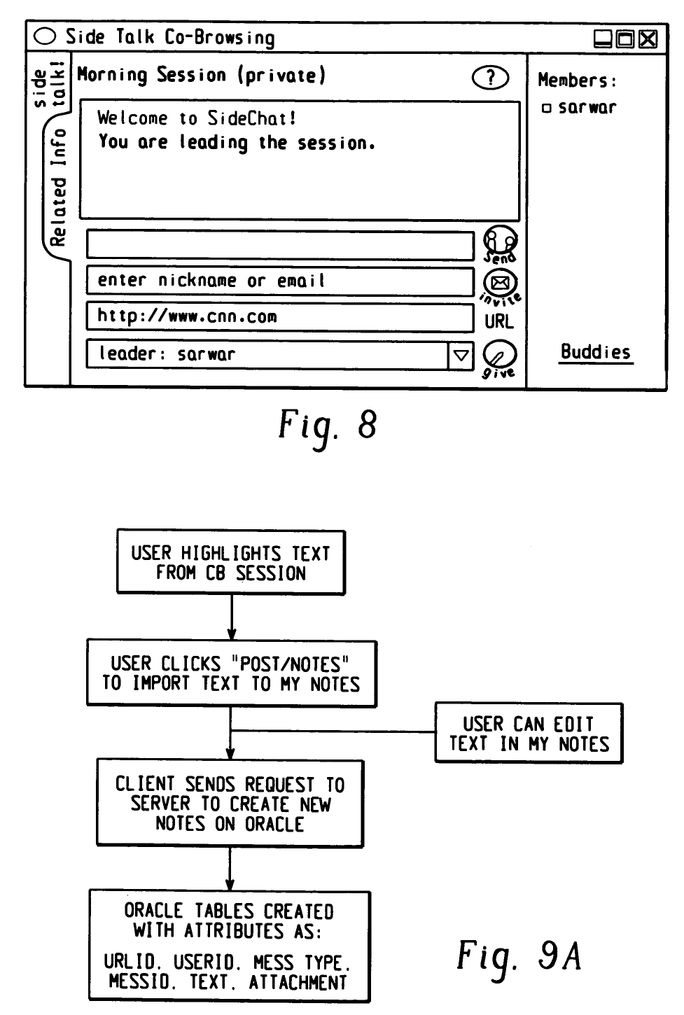

FIG. 8 shows that, while in a CB session, users can browse visited sites. The user enters other site links, chooses a link from a URL drop-down list comprising the list of sites visited or related to the present sit, or chooses a link they visited before the CB session. The user's browser companion dynamically adds any new URLs to the drop-down list. Once a CB session is closed the drop-down list may be destroyed from the session. The following algorithms will be updated on the list: For every leader variation {Add current URL to URL_LIST_OBJECT and Update drop-down list from URL_LIST_OBJECT}.

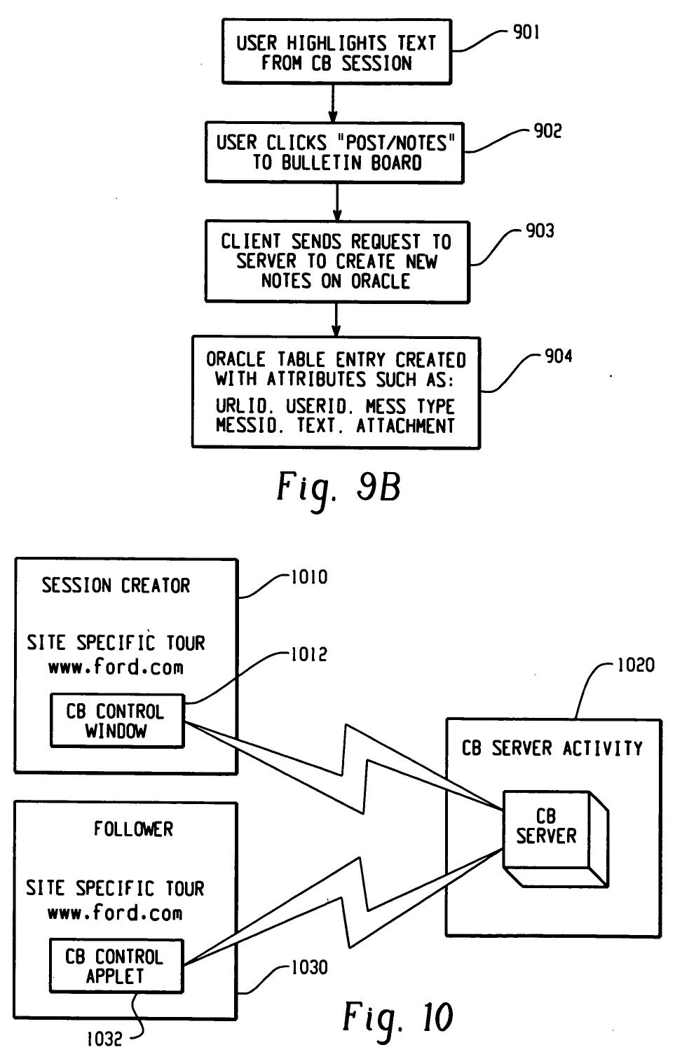

Notes (FIG. 9):

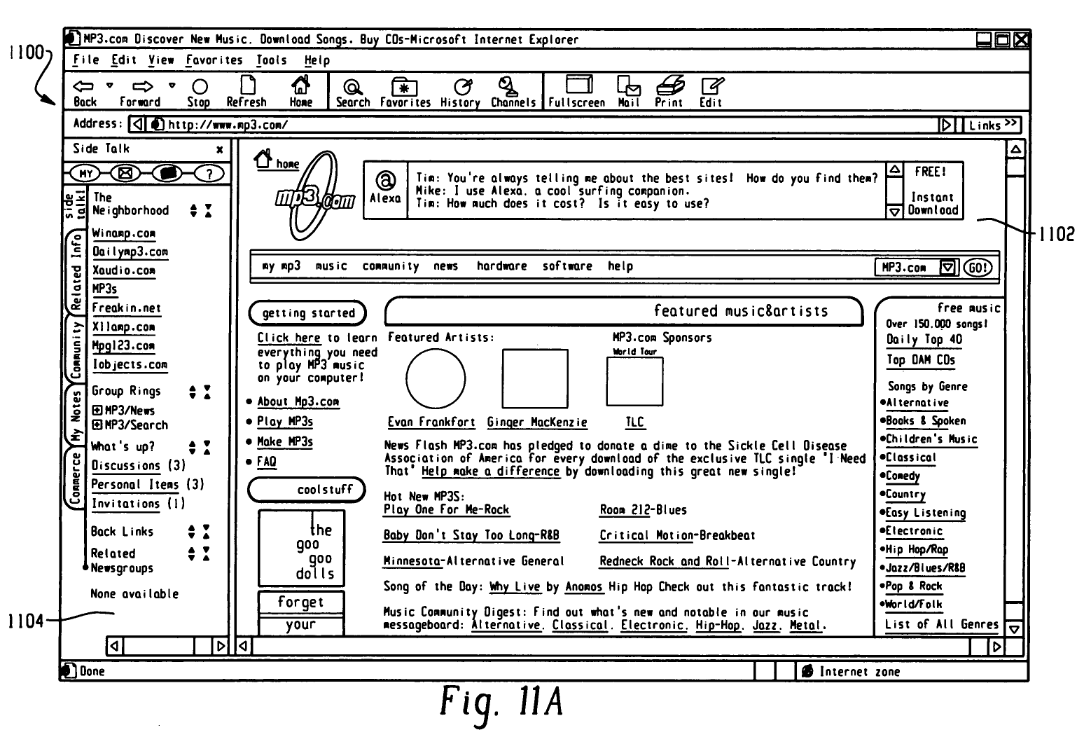

FIGS. 10A and 10B depict the processes necessary to make notes, whether public or private during a CB session. While browsing on a CB session, user can keep Notes. For instance, a user may highlight the selected discussion text and click on a link/command, such as ‘Post or Import to Notes.’ Those notes are then saved to the user's computer hard drive or stored on a server for later retrieval. The user can edit the text, e-mail the text, or send a request to create a new note message. If a server saves the notes, the user's browser companion requests a Bulletin Board Server to create new notes entries in a database, such as an Oracle database. Various attributes, as shown in FIG. 9A may be associated with the notes entries in the database in order to facilitate storage and retrieval. The Bulletin Board Server receives the request to create new notes, initiates a new entry to the database tables and saves all messages. If the user decides to e-mail the notes, the browser companion requests e-mail support from an SMTP Mail server, which handles the e-mail.

As shown in FIG. 9B, users can Post Public or Group Notes to Bulletin Board from CB session discussions. For instance, a user can highlight selected text (step 901), click the ‘Post or Import to Notes’ function (step 902) and designate the entry for public use in a Bulletin Board. The user's browser companion thereafter requests the server to create new notes (step 903). The Bulletin Board (or other) server initiates a new entry in the database tables, with attributes appropriate for later recalling the entry, and saves the entry (Step 904).

Exemplary Types of CB Sessions (FIG. 10):

Site Specific CB Session: A site specific CB session limits the collaborative browsing session to a single site or location, e.g., as seen in FIG. 10, the Ford Web site. The CB server supporting the site specific CB session limits the leader's surfing within a single site. For instance, the CB server constantly compares the leader's URL against a specific site URL stored in the session event records in order to confirm that the leader has remained within the particular site. If the user/leader seeks to exit the site, the CB server pops a message that travel outside the authorized site will terminate the user's session participation.

By way of example, suppose Ford has arranged to have a site specific CB session on its Web site. A Ford employee initially creates the CB session to answer questions about Ford's vehicles. During the CB session the Ford employee transfers leadership to one of the users. As long as that leader stays within the Ford site, the CB session continues. The CB server determines that the leader remains within the Ford site by ensuring that the leader's present URL matches at least www.Ford.com. If the leader attempts to leave the specific site, the CB server notifies the leader that the navigation is not allowed and gives the leader the option of passing leadership before so leaving or returning to a location within the site. If the leader is trying to leave the specific site and also created the CB session, the CB server may allow the leader/creator to terminate the site specific CB session.

In setting up site specific CB sessions, the present invention also gathers metrics concerning those sessions. These metrics may include: the number of site specific sessions entered into; the number of participants in each session; the amount of e-commerce generated by each session; the identities of the users in the site specific session; the identity of the leader of the site specific session, etc. These metrics can be used to track the efficacy of the site specific CB session in promoting the site's objectives, such as improving e-commerce at the site, confirming that the session leader, who may be an employee of the site owner, has done well leading the session and answering questions, or tracking the targeting and efficacy of advertising on the site in relation to CB session participants.

Site Specific CB Session with Non-subscribers: Another aspect of this invention is that it allows Web sites to create site specific CB sessions even among users who have not previously registered or otherwise obtained the type of browser functionality normally necessary to implement the functionality and advantages of this invention. FIG. 10 shows a Web site such as www.ford.com that allows visitors to initiate a CB session even if the visitors' browsers have not previously been upgraded to provide the CB session functionality of this invention or to have a plug-in to do that. FIG. 10 shows a previously-registered session creator 1010 whose browser companion initiates a session with CB Server 1020. A session participant 1030 has not previously registered to receive a browser companion according to this invention or a browser with the functionality of such a browser companion. The Ford Web site can offer such non-registered visitors the option of logging in as a guest user for the CB session, or of downloading the plug-in that implements the functionality of this invention.

Participant 1030, having elected to log in as a guest user, may be provided with a CB control window applet downloaded via Activex from either the CB server 1020 the server that hosts the Ford Web site. Such an applet provides the non-subscriber participant 1030 the browser functionality necessary to participate in the site-specific CB session depicted generally in FIG. 10. During that session, the session creator 1010 will have a normal CB control window 1012 that navigates and obtains status information from the CB server 1020. The CB control applet 1032 for the non-subscriber participant 1030 will similarly obtain status information from the CB server 1020 during the site specific CB session. Participant 1030 is a designated follower after logging in as a guest user.

Group Sessions: Using the system and architecture of this invention, subscribers can set up group sessions among various pre-defined lists of group members. For instance, using a customization feature, a subscriber can set up a personalized group, such as the subscriber's college alumni association or a work group. By clicking on the assigned group, the user can cause messages to be sent to each group member calendaring or scheduling a group CB session for a particular date. Thereafter, on that date and time, the user can initiate a collaborative browsing session across the selected group. During that browsing session, e-mail notifications go to each group member reminding them of the ongoing CB session. The session can be designated public or private in order to limit participation as desired. Additionally, during the session, other subscribers can be added to the group. As skilled persons will recognize, the types of groups that can take advantage of this functionality are virtually unlimited, ranging from the user's normal buddy lists to pre-defined work groups, hobby groups formed around common interests or hobbies or groups formed around particular organizations.

Moderated Sessions: Another aspect of group sessions is that a special administrative session can be set up that is a “moderated session.” Moderated sessions involve a large group of participants who listen to a single host and pass questions to a moderator, which can be a person or intelligent software component of this invention. This allows the host to address group questions without having to be inundated with a large number of questions. The moderator may filter the questions for common questions or other questions of value and then present those selected questions to the host. By way of example, suppose that a physician wishes to moderate a group of other doctors or interns on how to conduct a particular procedure. The physician-presenter may act as the host describing the general procedure. The administrator of the moderated session may act as the moderator, receiving questions during the physician-presenter's presentation, collating those questions, and then presenting selected questions to the physician-presenter. The particular questions presented are displayed to the entire group, as well as the physician-presenter's answers.

Recorded Tours and/or Footsteps: A recorded tour, or footsteps, consists of (1) a collaborative browsing session in which participants retrace the footsteps of a particular leader's previous tour, (2) a tour that participants have saved or recorded, and/or (3) a recording of all public chat or notes promulgated by participants during the session. As previously described, during the course of a particular CB session, the servers and client windows are constantly updating the leader and participants with the URLs, identities of participants and their status (e.g., rights) and other actions taken during the CB session. A recorded tour is simply a log of all of the URLs visited by the tour leaders during a particular session. Thus, as the participants go through the CB session, the server maintains the log. At the end of the session, the server offers the participants the option to save the site visits of the CB session. The users may see a drop down list that holds the visited URLs, as well as, if appropriate, the titles of the documents viewed during the CB sessions. A central place holder can be created to let any user take the tour in the future. Users' notes are also recorded. In essence, the recorded tour acts as a bookmark or favorite except that it applies to a number of the sites visited by the CB session participants.

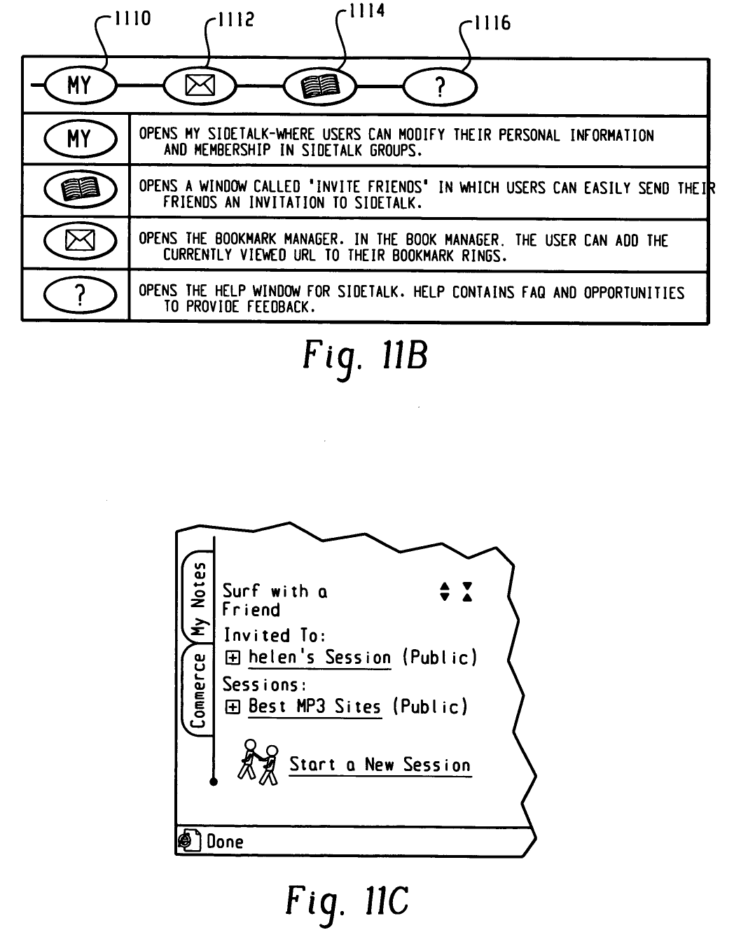

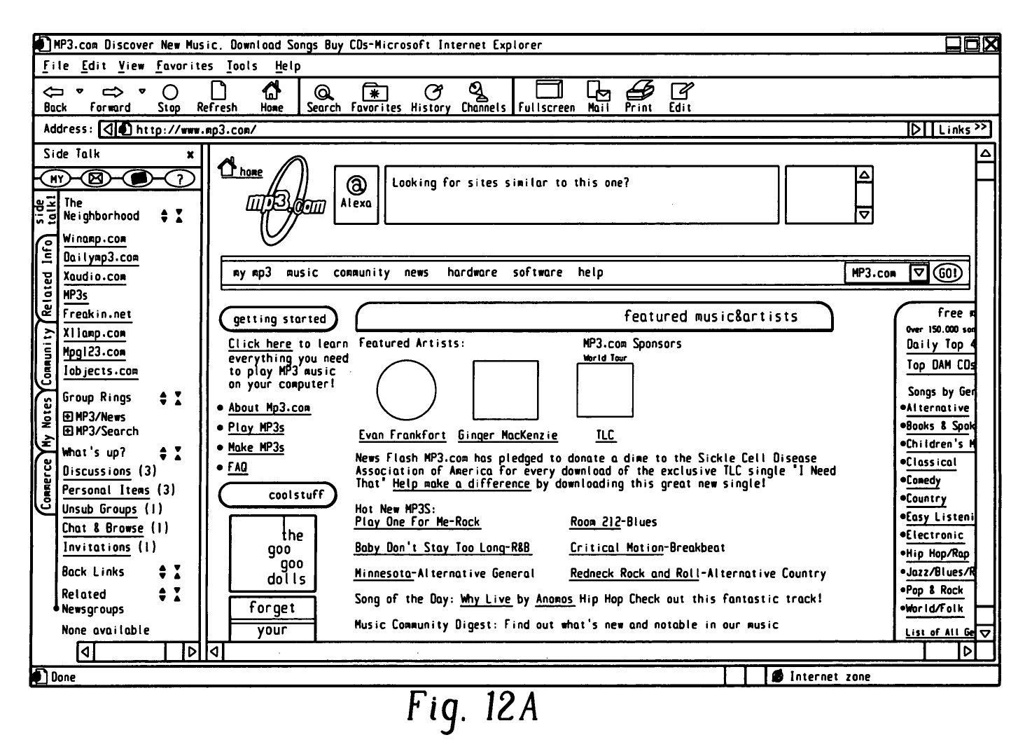

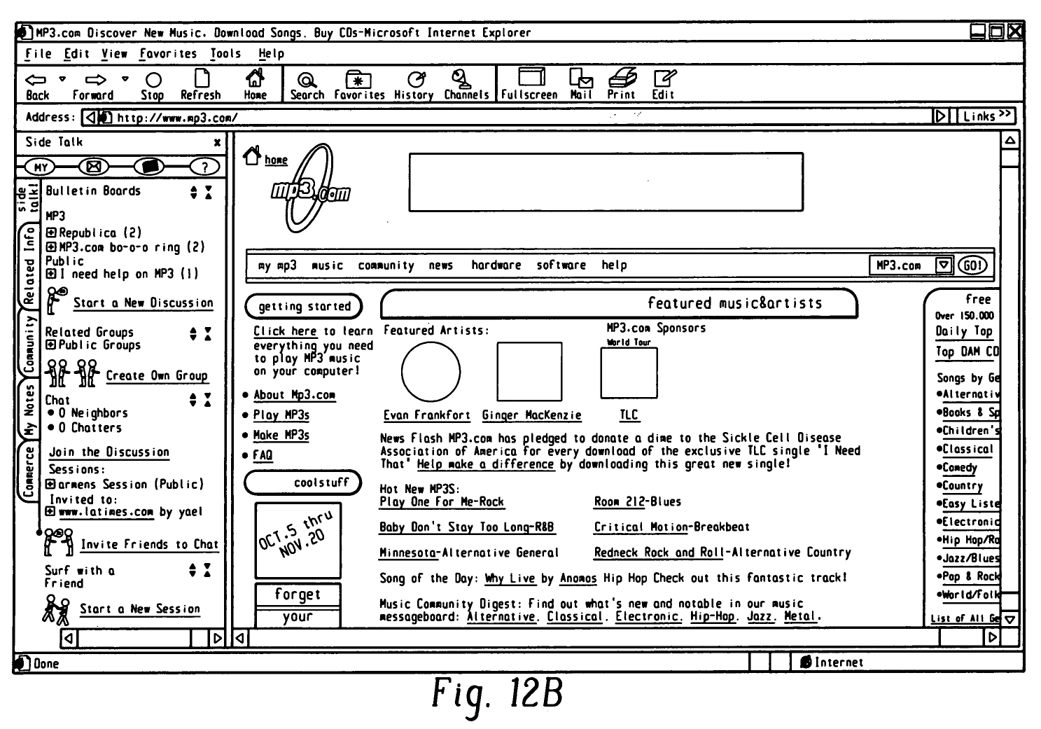

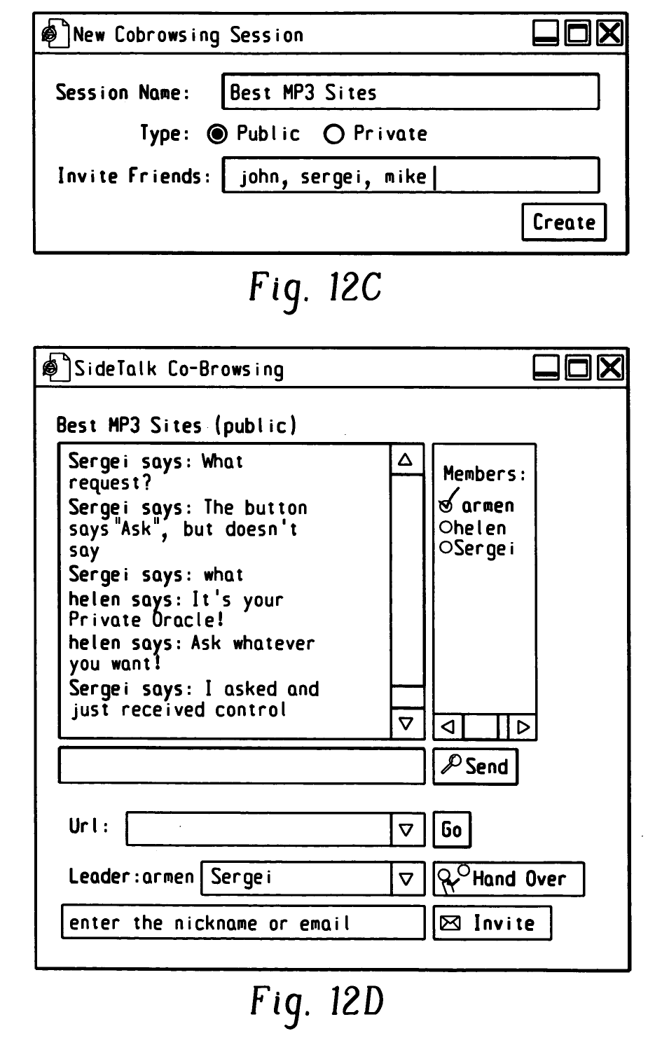

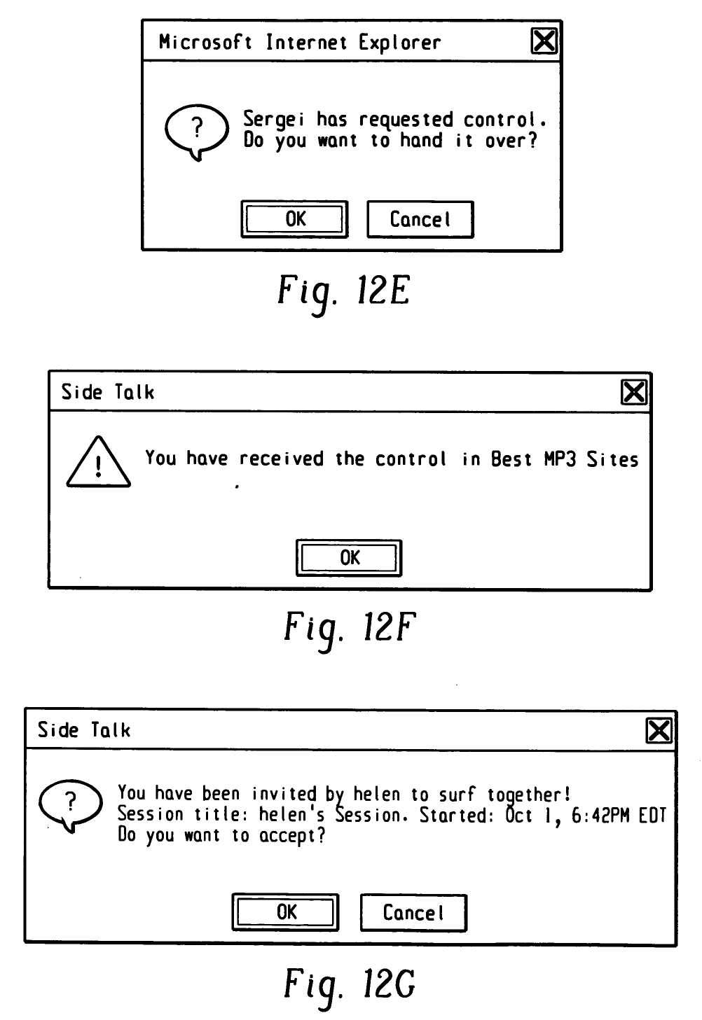

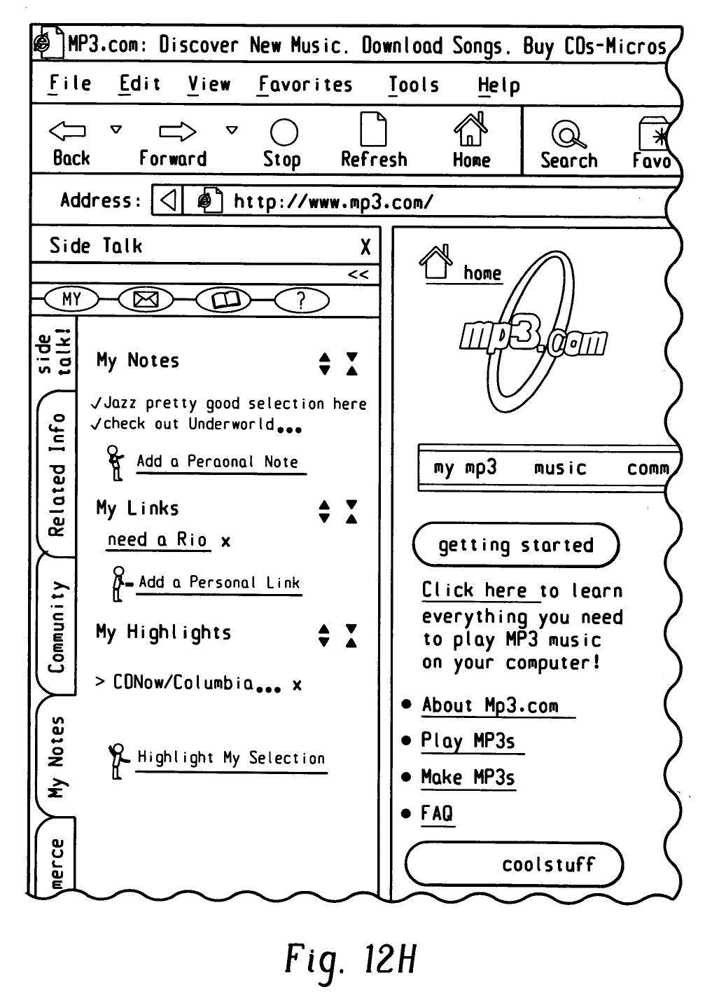

Exemplary Uses of the Present Invention (FIGS. 11-12):

Users who have loaded the browser companion of this invention can, at virtually any time during their Internet surfing experience, collaboratively browse various Web sites with friends or other interested users and located related information quickly and easily without interrupting their current activities for searching.

### EXAMPLE 1

Fred (29, lives in Manhattan, graphic designer) uses the present invention and wants to find information about the Rolling Stones online. A friend refers him to www.stones.com. When Fred visits the site, the first thing he sees is the site plus various related links. Fred surfs on the Stones.com site using the “Related Info” tab to get more information about the band. Fred sees there is an ongoing, public CB session with the nickname “StonesE-Tour” that is browsing the Internet in search of sites on the Stones. He does not have time to join in, but as he is about to leave for a related site to look for the words to the song “She Was Hot,” he sees under ‘What's Up’ that there is a public group about the Rolling Stones. Fred joins the group and posts a message on the bulletin board: “I need the words to ‘She Was Hot’”. A few days later, he goes back to stones.com and finds that another user of this invention who was looking at a different site, therollingstones.com and saw Fred's message, because the second site was linked with the first. This person posts a reply with a URL to go find the words.

Fred then wants to remember the URL for future reference, but doesn't want it to get lost in the hundred-or-so bookmark file he has in Internet Explorer. He goes to his Notes tab and posts the URL in a Personal Link, attaching the URL to stones.com's neighborhood. He then sees that he has a note to himself from the last time he was here, to look for Stones' tickets. He toggles the Commerce tab. CDNow is offering Fred CDs related to the stones, Barnes & Noble has a book available, and Ticketmaster has a link to the Stones concert, 10% off. This last offer is perfect—Fred clicks through to place an order for 2 tickets.

### EXAMPLE 2

By way of example, suppose Fran is shopping for a car, preferably a Ford, and wants to ask other people interested in cars about how she should go about the process. She goes to the community tab and sees discussions going on about Ford. She posts her own message in the Public forums. She also sees that a few people are a chat room in a “Ford Cars” neighborhood. There may be other users there who can help her. She enters and ‘listens’ to the discussion.

Within the “Ford (as” neighborhood, Fran finds some notes posted. Clicking on a “Notes” or bulletin board tab, Fran pulls up notes that include the name and telephone number of her local Ford dealer. She decides to give them a call. Before doing so, she clicks the Commerce tab. Both competitive and complementary products will be shown under the commerce tab. For instance, other car manufacturers, insurance companies, books, etc. will be listed to assist Fran in her information gathering and purchasing. More informed by this other information, Fran locates the Ford Web site and sees an Explorer that she likes. She decides to show it to her husband, Bill, who is at work on his PC. Activating her co-browsing tab, Fran invites Bill to join her in a collaborative browsing session. She shows him the Explorer; he replies by the Chat feature that he likes the car and, using Chat, they discuss what price to offer. Armed with this information, Fran locates the Ford dealer's page and opens up a chat dialog with the dealer to inquire about the car.

### EXAMPLE 3

Presently, some users attempt to shop together on the Web via Instant Messenger. The present invention dramatically improves this experience. For instance, suppose a group visits a Web site for shopping. Group members need to be allowed to scatter around the Web site in many directions without a leader because each member may be interested in different items. A “Pause” function may be implemented to keep the CB session active but to temporarily halt page relays to others. Then, when one user finds an item of interest, that user simply reinitiates the CB session, automatically gaining leadership and the ability to show other group members the item of interest. A “show group” function allows the user to show the group that item via a second browser window so that the other group members do not lose what they were observing in their own browser windows.

### EXAMPLE 4

FIGS. 11A-C show various screen faces depicting a particular embodiment of this invention, implemented under the brand name “Sidetalk,” including such details as the layout of the user's browser in a manner that allows the user easily to access the functionality of provided by this invention.

FIG. 11A shows an exemplary screen face of a Microsoft Internet Explorer browser 1100. The Browser 1100 has a main browser window 1102 and a sidebar 1104. The browser window 1102 displays a page from the MP3.com Web site. The sidebar 1104 displays a variety of information provided by the browser companion of this invention. For instance, the first tab shows “Related Info,” the second tab shows “Communities,” the third tab “My Notes” (e.g., the user's notes) and the fourth tab shows “E-commerce” links. Additionally, as shown in FIG. 11B, various toolbars can be used including a “My” button 1110 whereby users can modify their personal information and group memberships. A second button 1112 opens an invite friends window by which users invite friends to join into a collaborative browsing session. Other buttons 1114 and 1116 include a bookmark manager and help window. FIG. 11C shows ongoing collaborative-browsing sessions, as well as links to initiate the same.

FIGS. 12A-H depict various browser screens that result from users initiating various functionality during a co-browsing session.

For instance, FIG. 12A shows how the screen face lists related sites in a “neighborhood” section, ongoing discussions at a “Community” tab and a list of related Web sites that a group of users believe are relevant. (These linked Web sites are referred to as “Web rings”, which are Web sites that members of a group believe are relevant to whatever subject matter interests the group. FIG. 12B shows the same site, MP3.com, and the functionality by which the user can add messages to a group bulletin board associated with the MP3.com site. The bulletin board discussions can be public (open to all) or a group discussion that is available only to members of the group. Under the related groups section of FIG. 12B, the browser companion of this invention lists any public groups of users that have bookmarked the site that the user is viewing (e.g., the MP3.com site). The public groups that have bookmarked this site are ones that the user has not previously subscribed. Similarly, FIG. 12B shows a series of links, titled “Join the Discussion” with a listing of sessions that the user can seek to either join or to which the user has been invited. The session listing is obviously of public sessions; private sessions will not be shown.

As depicted in FIG. 12C, the sidebar displays the browser companion functionality by which users can initiate a new CB session. The initiating user assigns the CB session a name, designates its type (e.g., public or private), optionally describes any to which it should be linked, and then enters the initial invitations. Once the CB session is created, a collaborative browsing window, as depicted in FIG. 12D may be displayed along with the user's regular browser screens. As shown by FIG. 12D, the collaborative browsing window indicates the members of the session, the leaders' name and has various command buttons such as “Go”, “Hand over”, “Invite”, etc. FIGS. 12E-12G depict various notifications that CB session participants may receive upon requesting, or receiving control or being invited to join the session.

FIG. 12H depicts the notes tab on the browser companion's sidebar. The notes tab allows users to attach notes and/or highlights to a Web site, which materials will be retrieved whenever the user re-visits the site. In addition to notes and highlights, users can also attach to a particular site other links to other URLs. The highlights allow users to highlight specific text on a page and then send it to friends via e-mail. As long as the page has not been updated, when the user returns, the highlights will display.

As can be seen from the exemplary screens depicted in FIGS. 11 and 12, this invention includes aggregating multiple tools in a seamless fashion to enhance users' surfing experience. Thus, users can readily access related information, add their own information, chat with others, collaboratively browse with others and interactively manage and control such collaborative browsing sessions.

The foregoing is provided for purposes of illustrating, explaining and describing several embodiments of the present invention. Modifications and adaptations to these embodiments will be apparent to those of ordinary skill in the art and may be made without departing from the scope or spirit of the invention and the following claims. For instance, as the Internet and Web continue to evolve, the methods of the present invention can be deployed over new networks and systems and still remain within the scope of the present invention. Also, the embodiments described in this document in no way limit the scope of the below claims as persons skilled in this art recognize that the present invention can be easily modified for use to provide additional functionalities and for new applications.

What is claimed is:

1. A method for allowing a group of users interactively to tour a computer network, the method comprising:
allocating leadership of a touring session to a first group member, whereby the first group member can select other objects within the computer network for display to the group;
assigning each group member a predefined set of administrative rights that govern the group member's participation in the touring session; and
reallocating leadership upon receipt of a request from a second group member.

2. A method according to claim 1 in which at least one of the group members is assigned at least one of the following rights: the right to kick other group members from the touring session, the right automatically to take control of the touring session, and the right to terminate the session.

3. A method according to claim 1 further comprising the steps of (a) limiting the touring session to a Web site located within the computer network and (b) displaying information related to the Web site.

4. A method according to claim 1 further comprising the step of allowing at least one of the user's to attaching a note to a Web site and optionally to designate the note for sharing among other users.

5. A method for associating information with each Web site within a group of Web sites without requiring permission of a Web site operator, the method comprising:
aggregating at least two different Web sites to create a neighborhood;
associating shared information with either (1) the neighborhood or (2) each entry therein; and
accessing a Web server via a browser in order to retrieve the shared information when a user accesses the neighborhood or any entry therein.

6. A method according to claim 5 in which the neighborhood further comprises an object from the group consisting of a bulletin board, a collaborative browsing session, a chat session, a discussion group, and an event broadcast over the Internet.

7. A method according to claim 5 in which the shared information comprises data selected from the group consisting of notes added by a user, collaborative browsing sessions related to the neighborhood or entries therein, chat sessions related to the neighborhood or entries therein, discussion groups related to the neighborhood or entries therein, and a communication link related to the neighborhood or any entry therein.

8. A method according to claim 5 further comprising a step of authenticating the identity of the browser in order to determine whether the shared information may be retrieved by the browser.

9. A method for allowing visitors to a particular Web site to initiate a collaborative browsing session, the method comprising:
authenticating each session participant to confirm that each has a browser adapted to communicate with a server that supports a collaborative browsing (“CB”) session;
designating at least one administrator or at least one of the authenticated session participants to be the leader of a CB session; and
analyzing each of the leader's site changes to confirm that the CB session is operating within selected parameters.

10. A method according to claim 9 further comprising the step of at least temporarily provisioning any non-authenticated user with an applet for communicating with the server and, thereafter, authenticating that user.

11. A method for enhancing Internet surfing to provide users additional content, collaboration and context, the method comprising:
associating information with particular sites via a database that indicia describing a Web site with information related to the Web site;
providing each of a group of users with a browser companion;
assigning each user within the group of users a set of privileges controlling each users participation within a collaborative Internet touring session;
configuring each browser companion to:
1. communicate to a first server a particular user's present URL;
2. receive from a second server information concerning at least some of the administrative privileges assigned to each; and
3. display to a user information related to the present URL.

12. A method according to claim 11 further comprising the initiating a collaborative browsing session limited to a particular site or group of sites.
